(19) United States
(12) Patent Application Publication
(10) Pub. No.: US 2024/0413647 A1
(43) Pub. Date: Dec. 12, 2024

(54) A MODULAR AND RECONFIGURABLE BATTERY ENERGY STORAGE SYSTEM (RBESS)

(71) Applicant: University of Kansas, Lawrence, KS (US)

(72) Inventors: Amir Farakhor, Lawrence, KS (US); Huazhen Fang, Lawrence, KS (US)

(21) Appl. No.: 18/700,240

(22) PCT Filed: Oct. 11, 2022
(86) PCT No.: PCT/US2022/077918

§ 371 Date: Apr. 10, 2024

Related U.S. Application Data
(60) Provisional application No. 63/254,441, filed on Oct. 11, 2021.

(51) Int. Cl. H02J 7/00

(52) U.S. Cl. CPC H02J 7/0024; H02J 7/0019; H02J 7/00302; H02J 7/00306; H02J 7/0031; H02J 7/0048

(57) ABSTRACT

Embodiments provide modular and reconfigurable battery energy storage systems (RBESSs) exhibiting improved performance and power management capabilities. A power management system is provided to determine a power configuration for a plurality of power storage modules, each having a power storage device (e.g., a battery). The optimized power configuration balances a power load across active power storage modules (e.g., power storage devices being charged or discharged). The power management system is configured to control each power storage module/device on an individual basis, thereby enabling a greater degree of control and flexibility to achieve optimal balancing across a plurality of separate power storage devices within a power system (e.g., a battery pack).

### PRIORITY

The present application claims the benefit of and priority to U.S. Provisional Patent Application No. 63/254,441 filed Oct. 11, 2021, and entitled “A MODULAR, RECONFIGURABLE BATTERY ENERGY STORAGE SYSTEM (SBESS)”, the contents of which are incorporated herein by reference in their entirety.

### GOVERNMENT SUPPORT

This invention was made with government support under grant nos. 1763093 and 1847651 awarded by the National Science Foundation. The government has certain rights in the invention.

### TECHNOLOGY FIELD

The present disclosure generally relates to power devices and more particularly, to modular and reconfigurable battery energy storage systems.

### BACKGROUND

Lithium-ion battery energy storage systems (BESS) have proven themselves as an enabling technology for various applications, including electric cars, electric aircraft, smart grid, and space systems. Despite their high energy density and long cycle life, lithium-ion batteries suffer from safety risks, which trace to the high reactivity of lithium and flammability of the commonly used electrolyte solutions and are exacerbated by side reactions, aging, and degradation. Hence, it is imperative to ensure their safe and reliable operation, particularly in safety-critical applications. Reconfigurable BESS (RBESS) has attracted much attention as a promising means to achieve this end. An RBESS characteristically uses power electronics switches to make the connection among the constituent cells reconfigurable in order to provide the capability to bypass faulty cells without interrupting the operation of the system. For example, a switch may be controlled to disconnect a cell of the RBESS when the cell becomes faulty. As compared to conventional hardwired BESSs, which are vulnerable to a single cell failure due to their fixed cell configuration, RBESSs extend the useful life of the cells/power system, albeit at a diminished storage/output capacity relative to prior to the cell failure.

An additional challenge that presently exists in the field of BESS and RBESS architectures is second life systems, where power storage and discharge devices are repurposed to support new systems (e.g., using a battery retired from service in a vehicle to a power storage system). In the context of BESS architectures, and more particularly RBESS architectures, non-homogeneous second life power storage systems present new challenges that are not addressed by existing BESS/RBESS architectures. For example, non-homogeneous batteries may include batteries from different manufacturers, batteries from a single manufacturer having different primary life usage (e.g., a battery from manufacturer 1 that has been in use for 5 years and a battery from manufacturer 1 that has been in use for 7 years), or other differences. Such non-homogeneous power storage and discharge devices limit the capabilities of power systems because of their different performance capabilities (e.g., different power storage capacities, charge rates, discharge rates/power, etc.). To illustrate, such a non-homogeneous power system may be constrained to the capabilities of the lowest performance power storage and discharge devices (e.g., the system may be required to operate at a lower power output) or may shorten the useful life of the lowest performance power storage and discharge devices (e.g., by operating the lower performing power storage and discharge devices above their safe operating ranges). Thus, existing BESS and RBESS architectures provide some features that improve the safety conditions for various applications, such as those mentioned above, but are insufficient in many ways.

Current RBESS design and control capabilities provide two main ways to design RBESS circuit architectures. The first one builds and integrates a circuit of controllable power electronics switches with the cells. By controlling the switches, a cell can be put into or cut off from the connection with other cells when a fault occurs. Existing circuit topologies can also be used to realize arbitrary series and parallel connection among the cells or to produce multi-level and even AC voltage output. The second RBESS design involves the use of converters. In particular, such designs use centralized converter interfaces with a few cells and a selector to select and put the cells into operation. Some designs use pairs of converters to offer a bypass mode (e.g., instead of using switches as in the first design), but such designs are unable to offer flexible topology changes as in the switching circuit designs.

### SUMMARY

Embodiments of the present disclosure provide a modular and reconfigurable battery energy storage system (RBESS) architecture exhibiting improved performance and power management capabilities. In the disclosed RBESS architecture, a plurality of power storage modules are provided, each having a power storage device (e.g., a battery, etc.) and a power converter. Additionally, switching circuits are disposed between each module and may be used to connect the modules in parallel or in series or bypass one or more modules. A power management system is provided to determine an optimized power configuration that balances a power load across active power storage modules (e.g., power storage devices being charged or discharged). The power management system is configured to control each module on an individual basis, thereby enabling a greater degree of control and flexibility to achieve optimal balancing across a plurality of separate power storage devices within a power system (e.g., a battery pack).

The power management system may use and solve an optimization problem to generate the optimized power configuration for the RBESS array and use pre-specified rules or run optimization problems to identify the best connection topologies in real time. In an aspect, the optimization problem may consider real-time or current operating conditions of the RBESS array, such as temperature information, state of charge (SoC) information, or other factors. To guarantee the feasibility of the optimization problem, the power management system may introduce slack variables into the optimization problem. The individual control capabilities of the disclosed RBESS enable isolation (e.g., bypassing) of faulty cells within the RBESS array while the power converters may be used to compensate for any power loss attributed to the faulty cells, thereby enabling power output of the array to be maintained in the presence of faulty cells. Additionally, the operating conditions may be used to provide intelligent charging of the RBESS array, such as by taking into account SoC and temperature of each cell and altering charging operations to account for changes in these factors.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1A is a block diagram of a RBESS in accordance with aspects of the present disclosure;

FIG. 1B is a block diagram of another RBESS in accordance with aspects of the present disclosure;

FIG. 1C is a block diagram of another RBESS in accordance with aspects of the present disclosure;

FIG. 2 is a block diagram of a RBESS architecture in accordance with aspects of the present disclosure;

FIG. 3 is another block diagram of another RBESS architecture in accordance with aspects of the present disclosure;

FIG. 4 is a block diagram of another RBESS architecture in accordance with aspects of the present disclosure;

FIG. 5 is a block diagram of a RBESS architecture in accordance with aspects of the present disclosure;

FIG. 6 is a block diagram of a method for controlling an RBESS in accordance with aspects of the present disclosure;

FIG. 7A is a block diagram of a power storage module for an RBESS in accordance with the present disclosure;

FIGS. 7B and 7C show diagram of electrical and thermal models for a power storage module for an RBESS in accordance with the present disclosure;

FIG. 8 is diagram illustrating an exemplary linearization process in accordance with the present disclosure;

FIGS. 9A-9D show diagrams illustrating the SoC and temperature balancing performance using the proposed power management approach in an RBESS in accordance with aspects of the present disclosure;

FIG. 10 is a diagram showing evolution of slack variables in an optimization problem according to aspects of the present disclosure;

FIG. 11 is a diagram illustrating the power of the individual cells is regulated to vary from one to another using power management techniques in accordance with aspects of the present disclosure;

FIG. 12 is a diagram showing total power losses on the internal resistances of cells using power management techniques in accordance with aspects of the present disclosure;

FIG. 13 is a diagram illustrating the normalized RMS of the output power of the battery cells in comparison to their internal resistance values in accordance with aspects of the present disclosure;

FIGS. 14A-14C are images of an experimental setup used to test an RBESS architecture in accordance with aspects of the present disclosure;

FIGS. 15A-15D show results obtained during experimental setup used to test an RBESS architecture in accordance with aspects of the present disclosure;

FIG. 16 shows results obtained during experimental setup used to test an RBESS architecture in accordance with aspects of the present disclosure;

FIG. 17 is a block diagram of an exemplary hybrid RBESS system in accordance with aspects of the present disclosure;

FIG. 18A is a block diagram illustrating an embodiment of a 3-dimensional RBESS in accordance with aspects of the present disclosure;

FIG. 18B is a block diagram illustrating another embodiment of a 3-dimensional RBESS in accordance with the present disclosure;

FIG. 18C is a block diagram illustrating another embodiment of a 3-dimensional RBESS in accordance with the present disclosure; and

FIG. 19 is a block diagram of an embodiment of a diagnostic circuit in accordance with aspects of the present disclosure.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

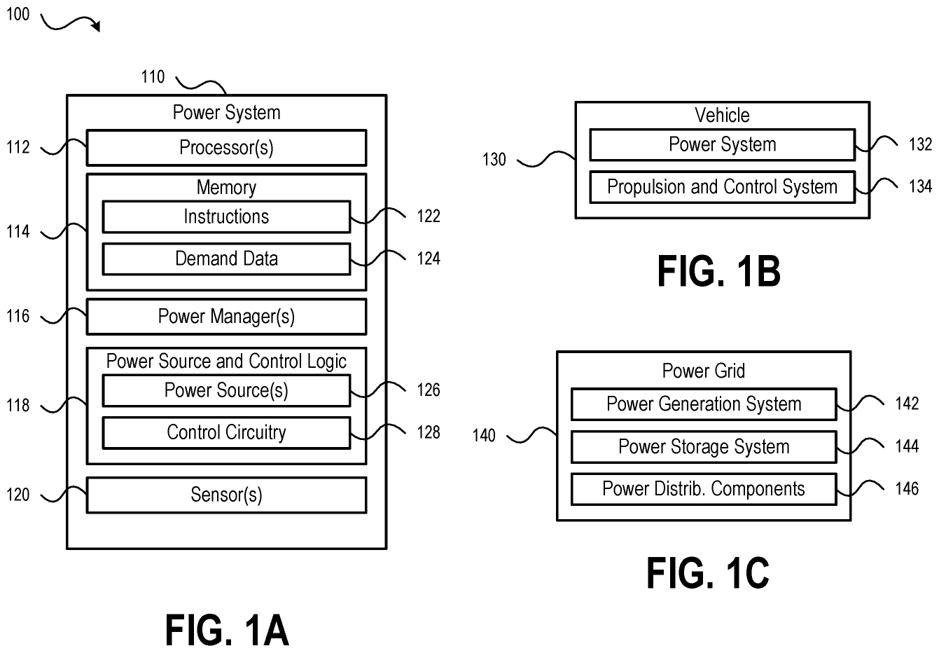

Referring to FIG. 1A, a block diagram of an RBESS architecture in accordance with aspects of the present disclosure is shown as RBESS 100. As shown in FIG. 1, the RBESS 100 includes a power system 110 having one or more processors 112, a memory 114, one or more power managers 116, power source and control logic 118, and sensors 120. The one or more processors 112 may include one or more microcontrollers, application specific integrated circuits (ASICs), field programmable gate arrays (FPGAs), central processing units (CPUs) having one or more processing cores, or other circuitry and logic configured to facilitate the operations of the power system 110 in accordance with aspects of the present disclosure. The memory 114 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. As shown in FIG. 1, the memory 114 may also store instructions 122 that, when executed by the one or more processors 112 (or other processing logic), cause the one or more processors 112 to perform operations for supporting a RBESS architecture in accordance with the present disclosure. Additionally, the memory 114 may store demand data 124. The demand data 124 may include data associated with power demand of a device supported by the power manager 116 and the power source and control logic 118. For example, the demand data 124 may indicate power needs of a device (e.g., a vehicle), a system (e.g., a power grid), and the like, and may be used by the power manager 116 in some aspects to control the power output by the power sources 126.

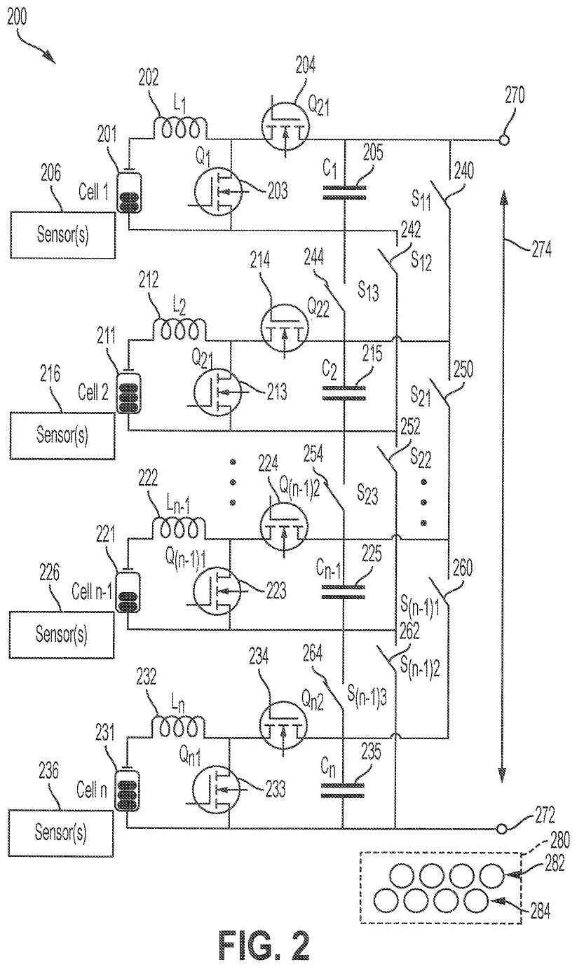

As described in more detail below, the power manager 116 may provide functionality to support control of the RBESS architecture. For example, the power manager 116 may provide functionality for bypassing faulty power storage devices (e.g., batteries, power cells, and the like), controlling characteristics of charging operations of power storage devices, controlling power output of the power storage devices, or other operations, as described herein. In an aspect, control of the RBESS architecture by the power manager 116 may be based on information obtained from the one of more sensors 120, as described in more detail below with reference to FIGS. 2-5.

The power source and control logic 118 may include power sources 126 and control circuitry 128. The power sources 126 may include power storage devices, such as batteries, battery packs, capacitor banks, or other devices configured to store electrical power. Moreover, power may be drawn from the power sources 126 to facilitate operation of a device, such as an electric vehicle, or to distribute the power to a remote system, such as via an energy grid or power distribution system. It is noted that the specific examples of devices and systems described as being powered by energy provided by the power sources 126 above have been provided by way of illustration, rather than by way of limitation and that the RBESS architecture shown in FIG. 1 may be readily applied to any device or system for which electrical power may be used to facilitate operations in whole or in part.

In addition to the power sources 126, the control circuitry 128 includes circuitry configured to facilitate reconfiguration of the RBESS, such as to bypass faulty ones of the power sources 126, control power output by the power sources 126, control charging of the power sources 126, and other operations involving collective or individual control of the power sources 126. To illustrate and referring to FIG. 2, a block diagram illustrating power and control logic of a RBESS architecture facilitating individual control of power sources in accordance with aspects of the present disclosure is shown as power and control logic 200. It is noted that the power and control logic 200 of FIG. 2 may correspond to power source and control logic 118 of FIG. 1. As shown in FIG. 2, the RBESS architecture 200 includes n battery cells, shown in FIG. 2 as battery cells 201, 211, 221, 231. In an aspect, the battery cells 201, 211, 221, 231 may be the power sources 126 of FIG. 1. Furthermore, it is noted that while described as battery cells, it should be understood power sources other than battery cells may be utilized in the power and control logic of RBESS architectures in accordance with the present disclosure, such as battery packs or other power storage devices. It also is noted that FIG. 2 shows the n cells as including 4 battery cells for purposes of illustration, rather than by way of limitation and that RBESS architectures in accordance with the present disclosure may be configured to include less than 4 or more than 4 battery cells (or other power storage devices) if desired.

Each of the n cells is connected with a power converter (e.g., a direct current (DC)/DC converter) to form a module (e.g., n modules, one for each of the n cells). It is noted that in FIG. 2 the power converters are shown as synchronous direct current DC/DC converters for purposes of illustration, rather than by way of limitation and that other types of converter implementations may be used in accordance with the concepts disclosed herein. In the exemplary embodiment of FIG. 2, the power converter for each of the modules includes 2 power switches (e.g., power switches 203, 204, 213, 214, 223, 224, 233, 234), an inductor (e.g., inductors 202, 212, 222, 232), and an output capacitor (e.g., capacitors 205, 215, 225, 235). For example, the module associated cell 201 includes inductor 202, power switches 203, 204, and capacitor 205; the module associated cell 211 includes inductor 212, power switches 213, 214, and capacitor 215; the module associated cell 221 includes inductor 222, power switches 223, 224, and capacitor 225; and the module associated cell 231 includes inductor 232, power switches 233, 234, and capacitor 235. Each of the modules of the power and control logic 200 are connected via a switching circuit that includes three power switches placed between every two adjacent modules. For example, in FIG. 2 switches 240, 242, 244, 250, 252, 254, 260, 262, 264 are shown, with switches 240, 242, 244 being disposed between the modules associated with cells 201, 211; switches 250, 252, 254 being disposed between the modules associated with cells 211, 221; and switches 260, 262, 264 being disposed between the modules associated with cells 221, 231. By appropriate reconfiguration of the switches 240, 242, 244, 250, 252, 254, 260, 262, 264, the switching circuit can bypass a module subject to faults and achieve arbitrary series or parallel connection among the various modules. Such switching capabilities enable a power management system (e.g., power manager 116 of FIG. 1) to provide individual control of power sources of the power and control logic 200 in a more robust manner than existing BESS and RBESS systems, which have limited capabilities (e.g., bypassing faulty cells, distributing power from one cell to another, etc.) and do not facilitate full control of each cell on an individual basis in the manner described herein in more detail below. It is noted that more or less switches could be used to connect adjacent cells if desired.

The power converter of each module provides bi-directional power processing to control charging (e.g., via input power port 270) and discharging (e.g., via power output port 272) of the corresponding cell (e.g., inductor 202, power switches 203, 204, and capacitor 205 provide bi-directional power processing control for charging and discharging cell 201; inductor 212, power switches 213, 214, and capacitor 215 provide bi-directional power processing control for charging and discharging cell 211; etc.) on an individual basis, thereby facilitating independent operational control and management of each cell. To illustrate, each cell may be operated to output the same or different power levels (e.g., cell 201 may be controlled via its corresponding power converter to output X volts, while another cell may be controlled via its corresponding power converter to output X volts or Y volts, where X≠Y). Additionally, faulty cells may be bypassed via appropriate configuration of the switches associated with the faulty cell. As explained above, in prior BESS and RBESS approaches, when a cell becomes faulty it may be bypassed, but such bypassing typically results in a loss of power output overall. In contrast, using the power and control logic 200 and its ability to control the power output on an individual cell or module basis enables other ones of the cells to be controlled to output greater amounts of power, thereby enabling safety to be achieved by bypassing faulty cells without reduced power output of the RBESS.

Similarly, each power converter may enable charging of its corresponding cell to be controlled on individually such that one or more cells may be charged while others are not charged; to enable different cells to be charged at different rates, current levels, etc.; enable all cells to be charged at the same rates, current levels, etc.; or other operations to control charging of each of the cells 201, 211, 221, 231 on an individual basis. This ability may be particularly useful in certain RBESS implementations that are currently not feasible using existing BESS and RBESS architectures, such as where the cells include second life power storage devices. Other operational control features may also be provided using the RBESS architecture 200 of FIG. 2, as described elsewhere herein.

To conceptually illustrate control functionality provided by the switches shown in FIG. 2, label the three switches (j) connecting adjacent modules i and i+1 as Sᵢⱼ for j=1, 2, 3. For switch Sᵢⱼ, Sᵢⱼ=1 when it is on, and Sᵢⱼ=0 when it is off. To bypass and isolate cell i for 1≤i≤n−1 from the rest of the power sources (e.g., isolate cell 201 from cells 211, or cells 211 from 221, cells 221 from 231, and so on), let Sᵢ₁=1 and Sᵢ₂=Sᵢ₃=0. To bypass cell n, let S(n−1)2=1 and S(n−1)3=S(n−1) 1=0. Modules i and i+1 may be configured in series when Sᵢ₁=Sᵢ₂=0 and Sᵢ₃=1, and in parallel when Sᵢ₁=Sᵢ₂=1 and Sᵢ₃=0. It is noted that the proposed design uses only 3(n−1) power switches for n cells, representing a reduction in the number of switches required by currently existing RBESS designs while still providing high reconfigurability. The circuit simplicity further results in convenient operation and reconfiguration. To illustrate, a cell requires only one switch to be on for the series and bypass configuration, and a parallel configuration needs only two switches to be on, as described above.

As shown above, the RBESS architecture of the present disclosure provides for high reconfigurability and control flexibility. Such features result in distinct benefits to powered systems and devices that utilize an RBESS architecture in accordance with the present disclosure. For example, the proposed RBESS design allows faulty modules to be bypassed and/or isolated while still maintaining the ability to provide a same power output if desired despite the loss of the faulty cell. When used in a battery pack, where each of the cells 201, 211, 221, 231 corresponds to a battery of the battery pack, the battery pack can continue to operate despite one of the battery cells becoming faulty. In contrast, prior BESS and RBESS approaches require the entire battery pack to be shut down as a whole. Further, following the bypass of a module, the switching circuit can reconfigure to redirect the power flow and share the load equally among the remaining in-service cells to promote balanced use of them, thereby maintaining the power output of the battery pack instead of experiencing a lower power output at output 272 as would be experienced using prior approaches.

Additionally, the power converters provide useful functions with their capability of power conversion and control. First, they can be used to regulate the output voltage so that the RBESS can supply desired or reference voltage. It is noted that the voltage supply can remain consistent before and after a fault-induced reconfiguration. Second, the power converters apply individual current or voltage control to the cells, thus making it possible to customize and optimize the charging/discharging for each cell based on its present condition (e.g., state of charge (SoC), temperature, or other characteristics). Such capabilities may be referred to as cell balancing, which may include charging the cells with high SoC less relative to the cells with low SoC or discharging the cells with high SoC more relative to the cells with low SoC. It is also viable to balance the cells based on temperature and state-of-health properties. For example, in a battery pack implementation cells (e.g., batteries) on the interior of the battery pack tend to experience higher temperatures compared to cells on the edges or exterior of the battery pack. As the temperature of certain cells increases the discharge (or charge) of those cells may be adjusted (or balanced) with the remaining cells to reduce the temperature of the (hotter) interior cells, which may prevent damage to the cells and extend their useful life (or second life).

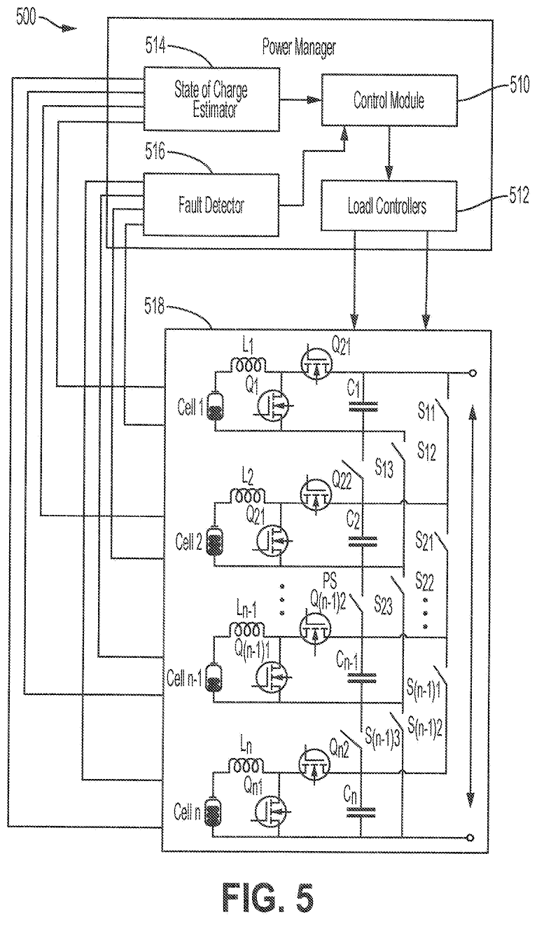

As shown in FIG. 2, each module may include one or more sensors, shown as sensors 206, 216, 226, 236, to facilitate monitoring of the state of each module and more particularly, the characteristics of the cells of each module. For example, sensors 206 may monitor characteristics of the cell 201, sensors 216 may monitor characteristics of the cell 211, sensors 226 may monitor characteristics of the cell 221, and sensors 236 may monitor characteristics of the cell 231. Exemplary sensors may include temperature sensors, SoC sensors or circuitry, moisture sensors, fault sensors or circuitry, current sensors, voltage sensors, or other types of sensors (e.g., soft sensors or algorithms to determiner internal conditions of a cell). As will be described in more detail below with reference to FIG. 5, information obtained by the sensors may be provided to a power management system (e.g., the power manager 116 of FIG. 1) to control a configuration of the RBESS, such as to control the configuration of the switches 240, 242, 244, 250, 252, 254, 260, 262, 264 during charging or discharging of the cells. Additionally, the power management system may be used to control a configuration of the RBESS with respect to a power level input/output of each of the cells/modules, where the power level input/output may be controlled on a per cell/module basis, as described above. It is noted that the description above and illustrated in FIG. 2 illustrates a one dimensional RBESS design but that the concepts shown in FIG. 2 could be readily applied to two dimensional and/or three dimensional power storage devices as well, such as a battery pack having batteries arranged into to two or more columns and two or more rows, as illustrated in insert 280 of FIG. 2, which shows a first row of batteries 282 and a second row of batteries 284. It is noted that insert 280 illustrates only 2 rows, each having 4 batteries for purposes of illustration, rather than by way of limitation and that the RBESS architecture of the present disclosure may be readily utilized in battery pack arrangements involving more than or less than 2 rows of batteries and in arrangements where each row of the battery pack includes more than or less than 4 batteries.

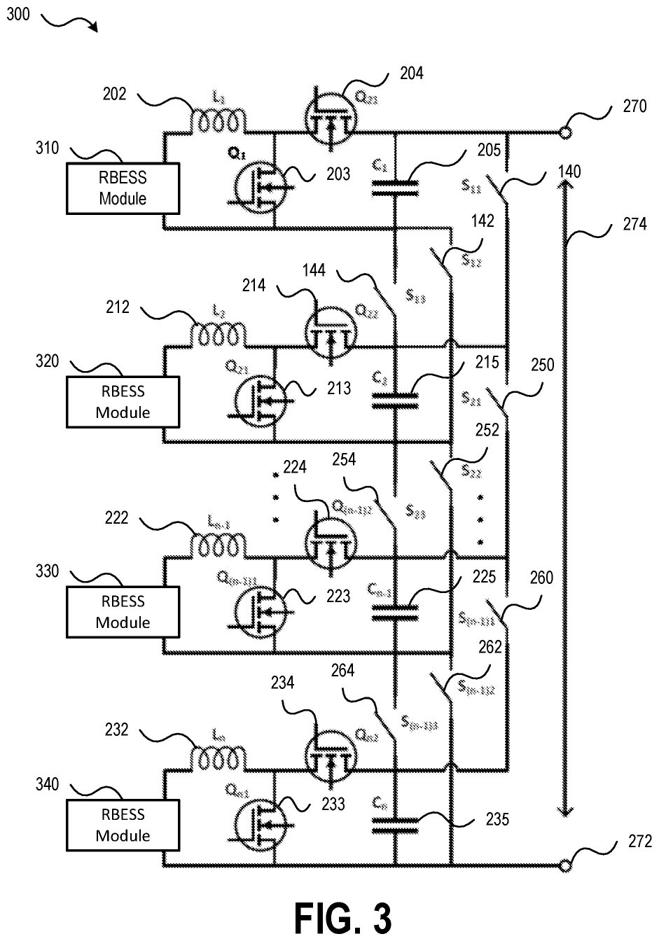

It is noted that the exemplary RBESS arrangement of FIG. 2 is also extensible and may be applied to create larger power storage devices and systems. For example, FIG. 3 shows another block diagram illustrating another block diagram of a RBESS in accordance with aspects of the present disclosure. As shown in FIG. 3, the RBESS architecture 300 shown in FIG. 3 includes the various power converters and switches described above with reference to FIG. 2, but each of the cells in the RBESS 300 may be another RBESS, such as the RBESS shown in FIG. 2. That is to say, the RBESS 300 of FIG. 3 is shown to include RBESS modules 310, 320, 330, 340, each having power and control logic similar to that described above and enabling individual control over the RBESS modules 310, 320,330, 340. However, rather than including cells such as individual batteries, each of the power sources of the RBESS 300 may also be, itself, an RBESS, such as the RBESS of FIG. 2. Thus, an RBESS module 310 may include the structure shown in FIG. 2 and be capable of providing individual control of the power storage devices of the RBESS module 310 as described above, but the RBESS 300 may further be able to regulate output of the RBESS modules 310, 320, 330, 340 individually, thereby providing individual control over those modules in a manner similar to that described above with reference to FIG. 2. Additionally, it is noted that while FIG. 3 illustrates a particular power converter implementation, embodiments of the present disclosure may be readily implemented using other types of power converters if desired.

The ability to implement such a nested RBESS may be particularly well suited to certain RBESS applications, such as applications involving heterogeneous power storage devices (e.g., batteries having different manufacturers or different electrochemistries) or applications involving second life power storage devices. For example, it is presently difficult to integrate heterogeneous cells from different manufacturers or even based on different electrochemistries into a common power storage system because the different batteries each exhibit different electrical and electrochemical properties. Similar challenges exist with respect to designing power systems using second life batteries, which may have different storage capacities, power output capabilities, or other properties that create non-uniform power characteristics that must be accommodated in the power storage system. Using the above-described RBESS architectures of FIGS. 2 and 3, power storage systems may be created in a manner that accommodates power storage devices having different electrical and electrochemical properties due to the ability to control each power storage device or cell on an individual basis. Such capabilities may thus enable efficient power storage systems to be realized, whether using heterogeneous batteries, second life batteries, or even homogeneous batteries (e.g., batteries having the same manufacturer or the same electrochemistries) that exhibit different electrical and electrochemical properties. Furthermore, the above-described RBESS architectures may also be readily applied to enable hybrid energy storage consisting of battery cells, supercapacitors, and even solar cells.

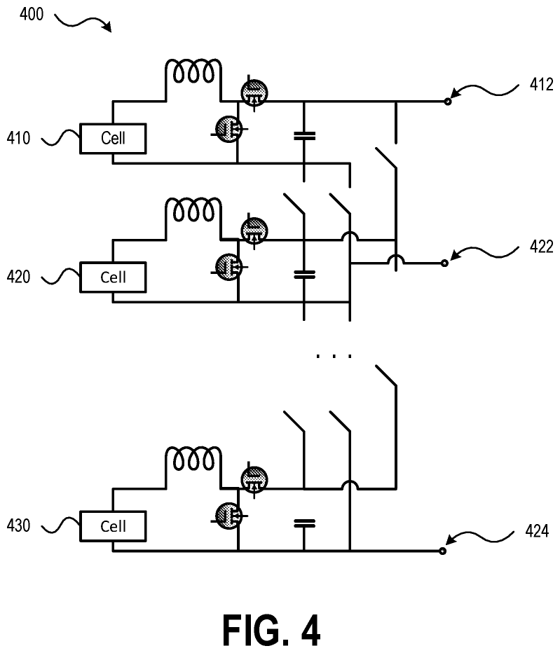

Referring to FIG. 4, a block diagram illustrating additional aspects of an RBESS architecture in accordance with aspects of the present disclosure is shown as an RBESS architecture 400. Like the RBESS architectures of FIGS. 2 and 3, the RBESS architecture 400 includes a plurality of cells 410, 420, 430, which may be power storage devices, as in the cells 201, 211, 221, 231 of FIG. 2, or may be RBESS modules, as in the RBESS modules 310, 320, 330, 340 of FIG. 3. Each of the cells 410, 420, 430 may be individually controlled and managed as described above with reference to FIGS. 2 and 3. As described above with reference to FIG. 2, the RBESS architecture 400 includes a power input port 412 through which power may be provided during charging. However, the RBESS architecture 400 differs from the RBESS architectures of FIGS. 2 and 3 by providing multiple power output ports 422, 424. In such a configuration, the RBESS architecture 400 of FIG. 4 may be controlled to provide a single power output (e.g., via the output port 422 or the power output port 424) or different power outputs (e.g., a first power output at the output port 422 and a different power output at the output port 424). Where a single power output is provided, the RBESS 400 may be controlled as described above with reference to FIGS. 2 and 3, such as by intelligent configuration of the switches and power converters. However, where multiple power outputs are provided, the RBESS 400 may provide control of the switching architecture to couple certain ones of the cells to the output 422 and other ones of the cells to the output 424, thereby enabling a single power storage system to provide a uniform power output or different power output on the fly.

Referring to FIG. 5, a block diagram illustrating a power management system for controlling an RBESS architecture in accordance with the present disclosure is shown as a power management system 500. In an aspect, the power management system 500 may be the power manager 116 of FIG. 1 and may be used to control operations and configuration of the RBESS architectures illustrated in FIGS. 2-4. As shown in FIG. 5, the power management system 500 may include a control module 510, load controllers 512, a SoC estimator 514, and a fault detector 516. As briefly described above, each cell may be associated with one or more sensors to facilitate monitoring of each cell on an individual basis. As illustrated in FIG. 5, the sensors for each cell may be coupled to the SoC estimator 514 and/or the fault detector 516 by traces 518. The traces 518 may be used to provide information obtained by the sensor(s) to the SoC estimator 514 and/or the fault detector 516. The SoC estimator 514 may be configured to determine the SoC of each cell and provide information regarding the SoC of each cell to the control module 510. Similarly, the fault detector 516 may be configured to detect when a cell becomes faulty based on information provided by the sensor(s) via the traces 518. When a faulty cell is detected the fault detector 516 may provide information to the control module 510 to indicate the faulty cell. Additionally or alternatively, the fault detector 516 may be configured to provide information regarding a fault state of each cell to the control module 510, such as to periodically provide information to the control module 510 that identifies each cell as being in a normal or faulty state.

As described above, an RBESS architecture in accordance with the present disclosure may enable dynamic reconfiguration of power storage and delivery components based on changing power needs and the state of the power storage and delivery devices. The control module 510 may be configured to reconfigure the RBESS architecture based on the information received from the SoC estimator 514 and the fault detector 516. For example, during charging the control module 510 may use SoC data to reconfigure the switches in a manner that achieves efficient charging. For example, the control module 510 may configure the switches to cut off power to one or more cells that have been fully charged and increase the power provided to other ones of the cells that are not fully charged. Additionally, if a temperature of one of the cells reaches a threshold level during charging (or discharging), as indicated by temperature information received from a temperature sensor, the control module 510 may reduce the amount of power delivered to the cell during charging (or drawn from the cell during discharging) in order to reduce the temperature of the cell. If the temperature drops below the threshold temperature during charging then the control module 510 may reconfigure the RBESS to charge each of the cells at a normal charge level (e.g., a charge configuration used prior to detecting that the cell's temperature exceeded the threshold). Similarly, the control module 510 may reconfigure the RBESS to charge each of the cells at a normal charge level (e.g., a charge configuration used prior to detecting that the cell's temperature exceeded the threshold) if the temperature drops below the threshold temperature during discharging. It is noted that in some instances the temperature may of the cell(s) may continue to increase despite reducing the power level used for charging (or discharging). In such instances the control module 510 may be configured to determine whether the temperature increases above a second threshold (e.g., a higher threshold than the first threshold). If the temperature increases above the second threshold, the control module 510 may reconfigure the RBESS to stop charging the cell or may stop discharging from the cell in an effort to reduce the temperature. In some implementations the control module 510 may be configured to utilize additional techniques to control temperature. For example, if the temperature is not falling despite the changes described above, the control module 510 may further reduce the charging/discharging of the cell in an attempt to accelerate cooling of the cell. As noted above, the control module 510 may also control other cells to compensate for any reduction in power output. For example, the control module 510 may be configured to control the power converters to adjust the amount of power drawn from the other cells, thereby enabling the output power to be maintained despite one or more cells having a reduced power output.

To control reconfiguration of the RBESS architecture to achieve the above-described functionality, the control module 510 may provide information to the load controllers 512. The load controllers may be configured to generate control signals that may be provided to the switches and power converters according to the optimizations determined by the control module 510. In an aspect, the load controllers 512 may include a load controller for each power converter and switch set (i.e., each set of switches between adjacent cells or modules). It is noted that the control signals may additionally include control signals to cause the RBESS to provide multiple power outputs, such as in the RBESS 400 of FIG. 4, such as by controlling the switches and power converters to direct the power output from a first subset of the cells to a first output port and to direct the power output from a other ones of the cells to a second output port, as described above with reference to FIG. 4.

As shown above with reference to FIGS. 2-5, RBESS architectures in accordance with the present disclosure provide enhanced control capabilities through control of cells on an individual basis. Such capabilities may be particularly useful for several applications for which prior RBESS techniques may not be suitable. For example and referring to FIG. 1B, a block diagram of a system implementing an RBESS in accordance with the present disclosure is shown as a system 130. The system 130 shown in FIG. 1B may correspond to an electric vehicle including a power system 132 and a propulsion and control system 134. The power system 132 may be a power storage and discharge system implemented using an RBESS architecture, as described above with reference to FIGS. 1A and FIGS. 2-5. For example, the power system 132 may include a plurality of power storage devices arranged into modules of an RBESS architecture, switching circuitry, and a power management system that enable various types of controls to be performed with respect to the plurality of power storage devices in accordance with the concepts disclosed herein. The propulsion and control system 132 may include various control systems (e.g., steering systems, flight management systems, actuators, servos, etc.), propulsion systems (e.g., motors, propellers, drive systems, fuel systems, etc.), sensors (e.g., an altimeter, a barometer, a pressure sensor, accelerometers, etc.), and other components adapted to enable the electric (or hybrid) vehicle to travel during navigation from the point of origin to the destination. It is noted that using a power system 132 implemented using an RBESS architecture in accordance with the present disclosure may improve the safety of the electric vehicle, such as by ensuring stable power output and dynamic cooling of the power storage devices used to provide operational power to the propulsion and control systems. Such capabilities may be especially important in certain electric vehicle use cases, such as electric aircraft (e.g., electric planes, electric helicopters, etc.). Additionally, by utilizing an RBESS architecture in accordance with the present disclosure, the cost of supplying power storage components for an electric vehicle may be significantly reduced (e.g., due to the ability to use multiple power storage devices having the same or different manufacturers, electrical properties, electrochemistries, etc.).

Referring to FIG. 1C, a block diagram illustrating an additional use case to which RBESS architectures in accordance with the present disclosure may be applied is shown. In particular, the exemplary use case of FIG. 1C illustrates a power grid 140 having a power generation system 142, a power storage system 144, and one or more power distribution components 146. The power generation system 142 may include devices and systems configured to generate electrical power, such as solar panels, wind turbines, hydroelectric power generators, coal power plant, or other power generation systems. The power generation systems 142 may be used to generate power for distribution by the power distribution components 146 of the power grid. For example, the power distribution components 146 may include power lines, transformers, and other components that may be used to transport electrical power from the power generation system 142 to various locations where the power may be consumed (e.g., homes, buildings, city infrastructure, etc.).

The power storage system 144 may be configured to capture excess power generated by the power generation system 142, such as may occur when electrical power usage is less than the production capacity of the power generation system 142. As described above, the capturing of power in the power storage system 144 may be achieved by charging power storage devices arranged in an RBESS architecture configured in accordance with the present disclosure, which may facilitate optimized capture of the excess energy. Moreover, the RBESS architecture disclosed herein may enable the power storage system 144 to be constructed at a scale suitable for supporting real world power demand environments (e.g., cities, regions, etc.) and at reduced costs due to the ability to use second life batteries and heterogenous power storage devices that can be controlled on an individual power storage device level. It is noted that the exemplary use cases illustrated in FIGS. 1B and 1C have been provided for purposes of illustration, rather than by way of limitation and that the RBESS architectures and concepts disclosed herein may be readily applied to other use cases where power storage and distribution are involved.

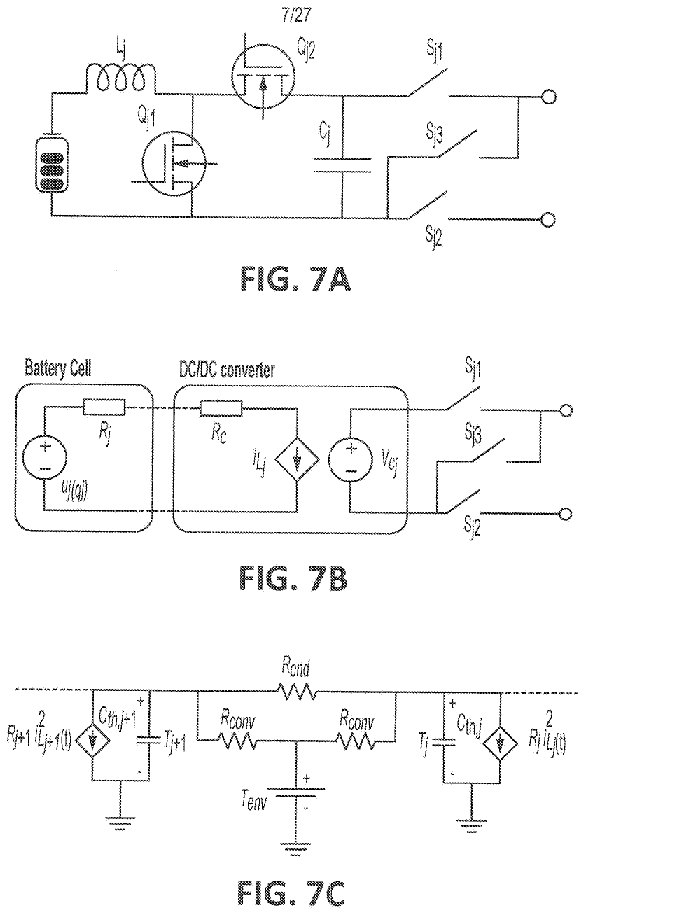

While the above discussion shows the merits of the proposed RBESS design, a modeling and optimal control approach to take advantage of the design will now be discussed. As a starting point, consider an RBESS consisting of n modules. As described above with reference to FIG. 2, each module includes a cell (e.g., a power storage device), a DC/DC converter, and three power switches. An example of a single such module is shown in FIG. 7A. Let J denote the set of in-service modules within the RBESS. The electrical model of module j for j ∈ J may be schematically illustrated as shown in FIG. 7B and includes two parts. The first part is an Rint model that describes the cell's electrical dynamics, which include an open circuit voltage (OCV) source uⱼ in series with an internal resistor Rⱼ. The Rint model's governing equations are:

$${\dot{q}}_{j} ( t ) = - \frac{1}{{\overline{Q}}_{j}} {i}_{{L}_{j}} ( t ) , \qquad ( 1 a )$$

$${v}_{j} ( t ) = {u}_{j} ( {q}_{j} ( t ) ) - {R}_{j} {i}_{{L}_{j}} ( t ) , \qquad ( 1 b )$$

where vⱼ, i_{L}_{ⱼ}, uⱼ, Q̅ⱼ, and \dot{q}ⱼ, are the terminal voltage of the cell, applied current in Ampere, OCV, capacity, and SoC, respectively. The internal power of the battery cell is given by:

$${P}_{{b}_{j}} = {u}_{j} ( {q}_{j} ( t ) ) {i}_{{L}_{j}} ( t ) . \qquad ( 2 )$$

The DC/DC converter is modeled as an ideal DC/DC transformer along with a series resistor R_{C} to capture power losses. Assuming that the reconfiguration switches cause no power loss, the module's output power Pⱼ can be calculated as:

$${P}_{j} = {u}_{j} ( {q}_{j} ( t ) ) {i}_{{L}_{j}} ( t ) - ( {R}_{j} + {R}_{C} ) {i}_{{L}_{j}}^{2} ( t ) , \qquad ( 3 )$$

where Rⱼi²(t) and R_{C}i²(t) represent the internal power losses of the cell and the converter, respectively.

The thermal dynamics of module j may be described using a lumped thermal model, shown in FIG. 7C. The thermal model of FIG. 7C considers factors related to cooling techniques that may be used to cool the RBESS. For example, in some implementations only ambient air may be used as a cooling source, while in other implementations artificial cooling sources, such as parallel forced air cooling may be used. It is noted that the particular cooling mechanisms used in conjunction with an RBESS configured according to the present disclose may vary according to the environment where the RBESS is deployed, the power levels used to charge and discharge the RBESS, or other factors. The thermal model of FIG. 7C may capture the heat transfer due to the convection between module j and the environment, \dot{Q}_{conv,j}, and the conduction between module j and its adjacent cells, \dot{Q}_{cnd,j}. The power loss caused by the internal resistor, Rⱼi₂Lⱼ, translates into heat generation, which becomes the main heating source. Combining all these factors, the thermal model is governed by:

$${C}_{th , j} {\dot{T}}_{j} ( t ) = {R}_{j} {i}_{{L}_{j}}^{2} ( t ) - {\dot{Q}}_{cnd , j} - {\dot{Q}}_{conv , j} , \qquad ( 4 a )$$

$${\dot{Q}}_{conv , j} ( t ) = ( {T}_{j} ( t ) - {T}_{env} ) / {R}_{conv} , \qquad ( 4 b )$$

$${\dot{Q}}_{cnd , j} ( t ) = ( 2 {T}_{j} ( t ) - {T}_{j + 1} ( t ) - {T}_{j - 1} ( t ) ) / {R}_{cnd} , \qquad ( 4 c )$$

where Tⱼ and Tₑₙᵥ are the cell's and environmental temperatures, respectively. In addition, the term C_{th,j} represents the thermal capacitance of the cell; R_{cnd} and R_{conv} are the thermal resistances between neighboring cells and between cell j and the environment, respectively. Here, R_{conv} depends inversely on the external surface area of the cell (Aⱼ) and the convective heat transfer coefficient between the cell's surface and the environment (h).

The above described electro-thermal model is concise but expressive and computationally efficient. Putting them together for all the modules, one can obtain a complete description of the dynamics of the RBESS, which allows us to perform optimal power management design subsequently.

The aim of the disclosed RBESS power management is to distribute the power load among the cells so that the power losses will be minimized under some key safety, balancing and power demand satisfaction constraints. To begin with, the optimization problem needs to be formulated. The total power losses of the RBESS can be expressed by:

$$J ( t ) = {\sum }_{j ∈ 𝒥} ( {R}_{j} + {R}_{C} ) {i}_{{L}_{j}}^{2} ( t ) . \qquad ( 5 )$$

The following objective function may be used to encompass the total power losses over a horizon:

$${\int }_{0}^{H} J ( t ) dt , \qquad ( 6 )$$

where H is the planning horizon length. For the sake of safety, each cell may be required to operate within some favorable current and SoC ranges:

$${i}_{{L}_{j}}^{min} \leq {i}_{{L}_{j}} \leq {i}_{{L}_{j}}^{max} , \qquad ( 7 a )$$

$${q}_{j}^{min} \leq {q}_{j} \leq {q}_{j}^{max} . \qquad ( 7 b )$$

where i^{min/max} and q^{min/max} are the lower/upper safety bounds for the current and SoC of cell j, respectively. It is noted that i_{L}_{ⱼ}^{min} can be set to be zero as the zero current means the bypass of the module. Further, the following SoC and temperature balancing constraints may be imposed to equalize the cells and make an even usage of them:

$$\vert {q}_{j} ( t ) - {q}_{avg} ( t ) \vert \leq Δ q , \qquad ( 8 )$$

$$\vert {T}_{j} ( t ) - {T}_{avg} ( t ) \vert \leq Δ T . \qquad ( 9 )$$

Here, q_{avg}(t) and T_{avg}(t) represent the average SoC and temperature of all the cells that belong to J, which may be calculated as:

$${X}_{avg} ( t ) = \frac{1}{card ( 𝒥 )} {\sum }_{j ∈ 𝒥} {X}_{j} ( t )$$

where X=q and T, and card(J) is the cardinality of J. The SoC and temperature thresholds Δq and ΔT determine the tolerated deviation of each cell's SoC and temperature from the average. While lower Δq and ΔT values force a more balanced SoC and temperature distribution among the cells, higher values allow more deviation for the cells' SoC and temperature from the average. One can empirically tune Δq and ΔT parameters to meet the SoC and temperature balancing requirements based on a specific application. To make the RBESS meet the power demands, the following output power satisfaction constraint may be used:

$${\sum }_{j ∈ 𝒥} {P}_{{b}_{j}} - ( {R}_{j} + {R}_{C} ) {i}_{{L}_{j}}^{2} = {P}_{out} , \qquad ( 10 )$$

where Pₒᵤₜ is the total power demanded of the RBESS.

Summing up the above, the power management approach provided by an RBESS architecture in accordance with the present disclosure may be based on addressing the constrained nonlinear optimization problem as follows:

$${min}_{{L}_{j} , j ∈ 𝒥} {\int }_{0}^{H} J ( t ) dt , \qquad ( 11 )$$

$$s . t . ( 1 b ) , ( 4 a ) , ( 7 a ) - ( 10 ) ,$$

This optimization problem pursues predictive minimization of the power losses while complying with the constraints that promote safety, SoC and temperature balancing, and power supply-demand match. It is noted that the optimization problem (11) is non-convex due to the nonlinearity of the equality constraint (10). Thus, the solution to this problem is neither trivial nor computationally cheap. To overcome the issue, the problem may be relaxed to formulate a convex optimization problem. The convexification is described in detail below.

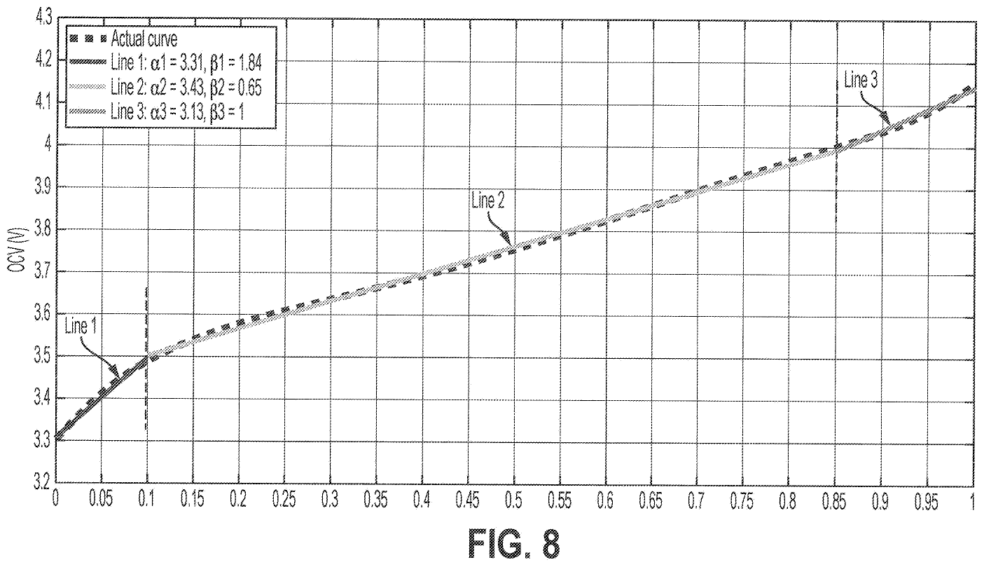

Convexification may begin with linearizing the SoC/OCV curve. Existing approaches for convexification typically perform the linearization for only the medium SoC range, where the OCV is closely linear with SoC for lithium-ion batteries. However, this treatment excludes the use of the low and high SoC ranges. To address the issue, a multi-segment linearization based on different SoC ranges may be introduced to approximate the complete SoC/OCV curve:

$${u}_{j} ( {q}_{j} ( t ) ) = {α}_{j}^{i} ( {q}_{j} ( t ) ) + {β}_{j}^{i} ( {q}_{j} ( t ) ) {q}_{j} ( t ) , \qquad ( 12 )$$

where αⱼⁱ and βⱼⁱ are the intercept and slope coefficients of the i-th line segment for cell j. An example of the linearization process described above is shown in FIG. 8, where the SoC/OCV curve taken from a real cell is approximated by three line segments. Differing from the prior approaches, αⱼⁱ and βⱼⁱ values are SoC-dependent, and the multi-segment linear approximation spans the SoC/OCV curve from 0 to 100% SoC. To ease the notation, the superscript i from the parameters αⱼⁱ and βⱼⁱ may be dropped from herein in the remainder of the description. Next, a convex model is presented by introducing the notion of accumulated energy Eⱼ to take the place of SoC. The accumulated energy of a battery cell can be expressed as:

$${E}_{j} ( t ) = \frac{1}{2} {C}_{j} {u}_{j}^{2} ( {q}_{j} ( t ) ) - {E}_{j}^{0} , \qquad ( 13 )$$

where Cⱼ=Q̅ⱼ/βⱼ and Eⱼ⁰=½Cⱼuⱼ²(qⱼ(0)) is the initial energy. Inserting (12) into (13) and using (1b), the dynamic equation of the cell's accumulated energy can be derived as:

$${\dot{E}}_{j} ( t ) = - {P}_{{b}_{j}} . \qquad ( 14 )$$

In the above, a desirably linear dynamic model is extracted to represent the evolution of Eⱼ(t) driven by P_{b}_{ⱼ}. Based on (14), the optimization problem can be reformulated to be one with respect to P_{b}_{ⱼ}, as will be seen later.

Proceeding forward, consider module j's power loss, Pₗ_{ⱼ}(t), which can be expressed in terms of P_{b}_{ⱼ} as:

$${P}_{{l}_{j}} ( t ) = \frac{( {R}_{j} + {R}_{C} ) {C}_{j} {P}_{{b}_{j}}^{2} ( t )}{2 ( {E}_{j} ( t ) + {E}_{j}^{0} )} . \qquad ( 15 )$$

As optimization goal is to minimize the total power loss, (15) can serve as an equality constraint. Since Pₗ_{ⱼ}(t) is not a linear function of P_{b}_{ⱼ}, the resulting optimization problem would be non-convex due to the nonlinearity of (15). Thanks to the fact that the objective function minimizes the total loss of the battery pack, (15) can be relaxed to comply with the convexity requirement:

$${P}_{{l}_{j}} ( t ) \geq \frac{( {R}_{j} + {R}_{C} ) {C}_{j} {P}_{{b}_{j}}^{2} ( t )}{2 ( {E}_{j} ( t ) + {E}_{j}^{0} )} , \qquad ( 16 )$$

by which the optimization problem will practically reduce Pₗ_{ⱼ}(t) to its lower bound. The safety constraints (7a)-(7b) can also be reformulated in terms of the P_{b}_{ⱼ} and Eⱼ as follows:

$$\sqrt{\frac{2}{{C}_{j}} ( {E}_{j} + {E}_{j}^{0} )} {i}_{{L}_{j}}^{min} \leq {P}_{{b}_{j}} \leq \sqrt{\frac{2}{{C}_{j}} ( {E}_{j} + {E}_{j}^{0} )} {i}_{{L}_{j}}^{max} , \qquad ( 17 a )$$

$$\frac{1}{2} {C}_{j} {u}_{j}^{2} ( {q}_{j}^{min} ( t ) ) \leq {E}_{j} + {E}_{j}^{0} \leq \frac{1}{2} {C}_{j} {u}_{j}^{2} ( {q}_{j}^{max} ( t ) ) . \qquad ( 17 b )$$

Similarly, the SoC balancing constraint (8) translates into the following:

$$\vert \frac{2}{{C}_{j}} {E}_{j} ( t ) - \frac{1}{card ( 𝒥 )} {\sum }_{i ∈ 𝒥} \frac{2}{{C}_{i}} {E}_{i} ( t ) \vert \leq Δ {E}_{j} , \qquad ( 18 )$$

where ΔEⱼ= (α+βⱼΔq)²-αⱼ². It is worth noting that the SoC balancing constraint, either (8) or (18), may result in infeasibility for the optimization problem, when Δq or ΔE fails to bound the cells' initial difference in SoC. The same issue applies to the temperature balancing constraint (9). Once this happens, the infeasibility will cause the power optimization procedure to abort. While it is possible to make ΔE and ΔT large enough to forestall the issue, this will sacrifice the achievable performance in both power loss minimization and cell balancing. To guarantee the feasibility, slack variables may be introduced to modify the constraints in (18) and (9) as follows:

$$\vert \frac{2}{{C}_{j}} {E}_{j} ( t ) - \frac{1}{card ( 𝒥 )} {\sum }_{l ∈ 𝒥} \frac{2}{{C}_{l}} {E}_{l} ( t ) \vert \leq Δ {E}_{j} + {ξ}_{j}^{( E )} , \qquad ( 19 )$$

$$\vert {T}_{j} ( t ) - {T}_{avg} ( t ) \vert \leq Δ T + {ξ}_{j}^{( T )} , \qquad ( 20 )$$

where ξⱼ^{(E)}, ξⱼ^{(T)}≥0 denote the SoC and temperature slack variables, respectively. The slack variables can be included into the objective function to penalize potential constraint violations. As such, if a cell's SoC or temperature is beyond the constraints, it will be driven close to the constraints by heavily penalizing the corresponding slack variables, without compromising the feasibility. The use of the slack variables will also improve the power control flexibility, as described in the exemplary simulation study described below. Based on the above, a convex relaxation of the problem in (11). Here, the focus is also turned to discrete-time optimization for the sake of computation, which may be achieved by applying the forward Euler method to (4) and (14) with the sampling time of Δt. The optimization variables may be denoted as zⱼ=[P_{b}_{ⱼ}, Pₗ_{ⱼ}, Eⱼ, Tⱼξⱼ^{(E)}, ξⱼ^{(T)}]^{T}, j ∈ J. From the above, a convex optimization problem for the RBESS power management may be formulated as:

$${min}_{{z}_{j} , j ∈ 𝒥} {\sum }_{k = 0}^{H} {\sum }_{j ∈ 𝒥} {P}_{{l}_{j}} [ k ] + {λ}^{( E )} {ξ}_{j}^{( E )} [ k ] + {λ}^{( T )} {ξ}_{j}^{( T )} [ k ] ,$$

Safety constraints for the optimization problem may be given by:

$$\sqrt{\frac{2}{{C}_{j}} ( {E}_{j} [ k ] + {E}_{j}^{0} )} {i}_{{L}_{j}}^{min} \leq {P}_{{b}_{j}} [ k ] \leq \sqrt{\frac{2}{{C}_{j}} ( {E}_{j} [ k ] + {E}_{j}^{0} )} {i}_{{L}_{j}}^{max} ,$$

$$\frac{1}{2} {C}_{j} {u}_{j}^{2} ( {q}_{j}^{min} [ k ] ) \leq {E}_{j} [ k ] + {E}_{j}^{0} \leq \frac{1}{2} {C}_{j} {u}_{j}^{2} ( {q}_{j}^{max} [ k ] ) ,$$

Balancing constraints for the optimization problem may be given by:

$$\vert \frac{2}{{C}_{j}} {E}_{j} [ k ] - \frac{1}{card ( 𝒥 )} {\sum }_{l ∈ 𝒥} \frac{2}{{C}_{l}} {E}_{l} [ k ] \vert \leq Δ {E}_{j} + {ξ}_{j}^{( E )} [ k ] ,$$

$$\vert {T}_{j} [ k ] - {T}_{avg} [ k ] \vert \leq Δ T + {ξ}_{j}^{( T )} [ k ] ,$$

Power loss constraint for the optimization problem may be given by:

$${P}_{{l}_{j}} [ k ] \geq \frac{( {R}_{j} + {R}_{C} ) {C}_{j} {P}_{{b}_{j}}^{2} [ k ]}{2 ( {E}_{j} [ k ] + {E}_{j}^{0} )} ,$$

Energy dynamics for the optimization problem may be given by:

$${E}_{j} [ k + 1 ] - {E}_{j} [ k ] = - {P}_{{b}_{j}} [ k ] Δ t ,$$

Thermal dynamics for the optimization problem may be given by:

$${T}_{j} [ k + 1 ] = {T}_{k} [ k ] + \frac{Δ t}{{C}_{th , j}} [ {P}_{{l}_{j}} [ k ] - ( {T}_{j} [ k ] - {T}_{env} ) / {R}_{conv} - ( 2 {T}_{j} [ k ] - {T}_{j + 1} [ k ] - {T}_{j - 1} [ k ] ) / {R}_{cnd} ] ,$$

Power supply-demand balance for the optimization problem may be given by:

$${\sum }_{j ∈ 𝒥} {P}_{{b}_{j}} [ k ] - {P}_{{l}_{j}} [ k ] = {P}_{out} [ k ] , \qquad ( 21 )$$

where λ^{(E)} and λ^{(T)} are the respective penalty weights for ξ^{(E)} and ξ^{(T)}. The above outlined optimization problem is verifiably convex as a result of the convex cost function and constraints. The convexity makes it advantageous in practice as robust algorithms are available to find out its global optimum with efficient computation. The introduction of the slack variables also makes the problem always feasible.

The problem outlined above is designed to be implemented in a receding-horizon manner which will bring three benefits. First, predictive optimization over a limited time horizon rather than the whole mission duration will make the computation more manageable. Second, the receding-horizon power control can better respond to changes that occur to the RBESS in operation (e.g., fault-triggered cell bypass and switching circuit reconfiguration). Finally, the SoC change in each receding horizon is slight, so the optimization only needs to consider a single SoC/OCV linear segment and hence runs more efficiently.

As explained above with reference to FIGS. 1-5, the RBESS architecture disclosed herein allows dynamic switching of the power switches to bypass faulty cells, ensuring continuous system operation. Following the bypass, an important question is how to reconfigure the connection topology among the cells. However, it is not easy to identify a complete answer, as the large discrete reconfiguration decision space due to the use of switches would defy an exhaustive search for an optimal topology. In addition, inappropriate reconfiguration may produce poor topologies to cause short circuits or other issues.

In an aspect, an efficient heuristic may be leveraged (e.g., by a power management system) to address the question, as outlined below. Suppose that all the remaining cells are approximately uniform in SoC and temperature at the time of the reconfiguration, since the power management based on (21) has driven cell balance. The reconfiguration then should yield a topology that facilitates a balanced use of the cells and makes every cell take an even power load. A straightforward topology design to fulfill this need is one based on nₛ serially connected modules with each module consisting of nₚ cells in parallel connection. This topology may be denoted as nₚPnₛS. In an aspect, nₛ and nₚ may be determined by:

$${n}_{s} = \frac{{V}_{t}^{*}}{{V}_{C}^{max}} , {n}_{p} = \frac{{I}_{out}}{{i}_{C}^{max}} , \qquad ( 22 )$$

where Vₜ* is the desired terminal voltage; V_{C}^{max} and i_{C}^{max} are the maximum output voltage and current stresses of the DC/DC converters, and Iₒᵤₜ=Pₒᵤₜ=Vₜ* is the output charging/discharging current of the battery pack. Subsequently, the RBESS can follow the series/parallel switching analysis as outlined above to reconfigure the switch circuit. Note that the proposed power management approach determines the optimal charging/discharging power of the cells and is not affected by any arbitrary series and parallel connections among the cells from the power perspective.

This heuristic-based reconfiguration mechanism is computationally fast, fail-safe, and easy to implement. Further, it promotes system-wide cell balance and fits together with the power management in (21). Below, an algorithm summarizing the overall RBESS management approach is shown:

Algorithm 1 Power management with reconfiguration

| | |
|---|---|
| 1: | for Run-time do |
| 2: | if a fault occurs to cell i then |
| 3: | Bypass cell i |
| 4: | Determine the set of the in-service cells [symbol] |
| 5: | Calculate nₛ and nₚ from (22) |
| 6: | Reconfigure the switch circuit S_{i1:3}, i = 1, 2, ...n |
| 7: | end if |
| 8: | Run the optimal power management strategy (21) |
| 9: | return P_{b}_{ⱼ} |
| 10: | if P_{b}_{ⱼ} == 0 for any j then |
| 11: | Bypass cell j |
| 12: | end if |
| 13: | end for |

This section presents simulation results to evaluate the proposed RBESS design and power management approach. Table I summarizes the specifications of the RBESS under simulation.

TABLE I
SPECIFICATIONS OF THE PROPOSED RBESS

| Symbol | Parameter | Value [Unit] | |
|---|---|---|---|
| n | Number of battery cells | 15 | |
| v | Cell nominal voltage | 3.6 | [V] |
| Q̅ | Cell nominal capacity | 2.5 | [A · h] |
| R | Cell internal resistance | 31.3 | [mΩ] |
| [q^{min}, q^{max}] | Cell SoC limits | [0.05, 0.95] | |
| [i^{min}, i^{max}] | Cell current limits | [−10, 10] | [A] |
| v_{cut-off} | Cell cut-off voltage | 3.3 | [V] |
| Cₜₕ | Thermal capacitance | 40.23 | [J/K] |
| A | External surface area | 0.0042 | [m²] |
| h | Convection heat | 5.8 | [W/(K · m²)] |
| | transfer coefficient | | |
| R_{conv} | Convection thermal resistance | 41.05 | [K/W] |
| R_{end} | Conductance thermal resistance | 26.6 | [K/W] |
| Tₑₙᵥ | Environment temperature | 298 | [K] |
| Δq | SoC balancing threshold | 1% | |
| ΔT | Temperature balancing threshold | 0.5 | [K] |
| Δt | Sampling time | 1 | [s] |

The battery cells used in the experimental setup were Samsung INR18650-25R, and their parameters are identified in Table I above, with the SoC/OCV relationship approximating that shown in FIG. 8. The SoC/OCV curve was approximated using a piecewise linear function with three segments that together span from zero to 100% SoC. The power load profile for Pout was obtained by repeating the scaled Urban Dynamometer Driving Schedule (UDDS). A CVX package was used to configure and solve the convex optimization problem in (21) to compute P_{b}. The optimization runs over a receding horizon of 20 seconds (i.e., H=20).

The initial SoC of the cells was drawn from a normal distribution with mean of 90% and variance of 3%. Similarly, the initial temperature of the cells follows a normal distribution with mean of 308 K and variance of 3 K. In order to investigate whether the power management can handle the cells' heterogeneity, a white Gaussian noise with variance of 4 m is added to the internal resistance value of each cell. Furthermore, it is assumed that cells 4, 8, and 14 are bypassed and isolated from the battery pack at the 2,000th, 4,000th, and 6,000th seconds, respectively.

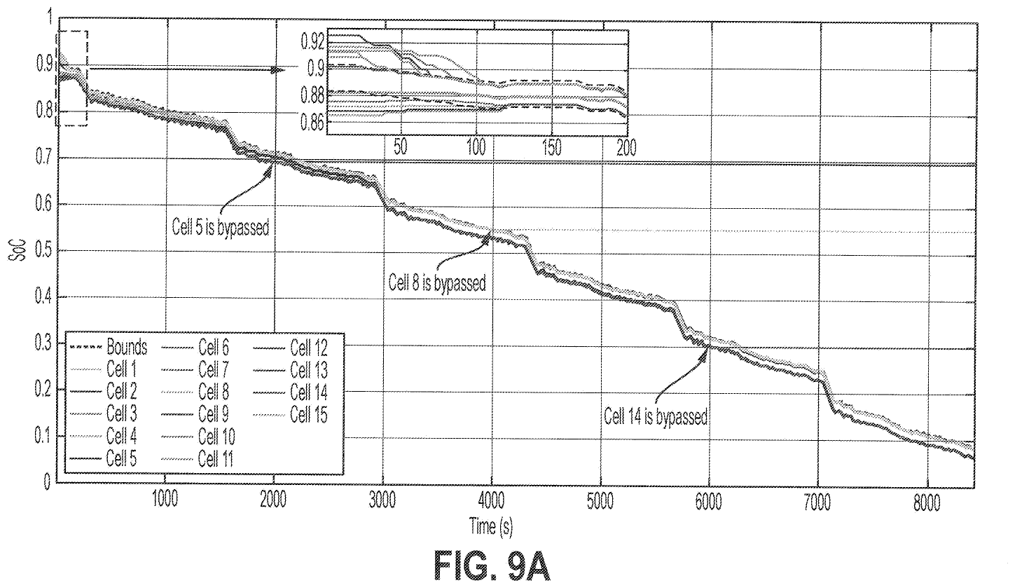

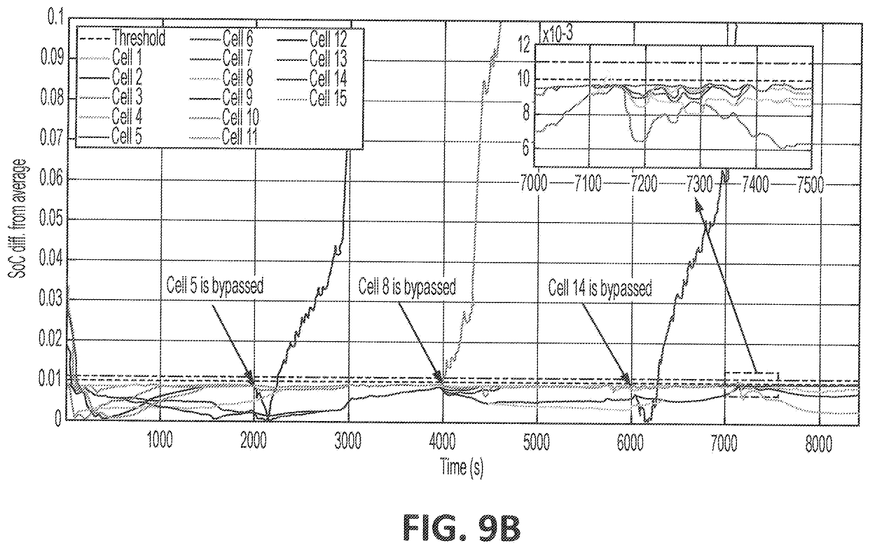

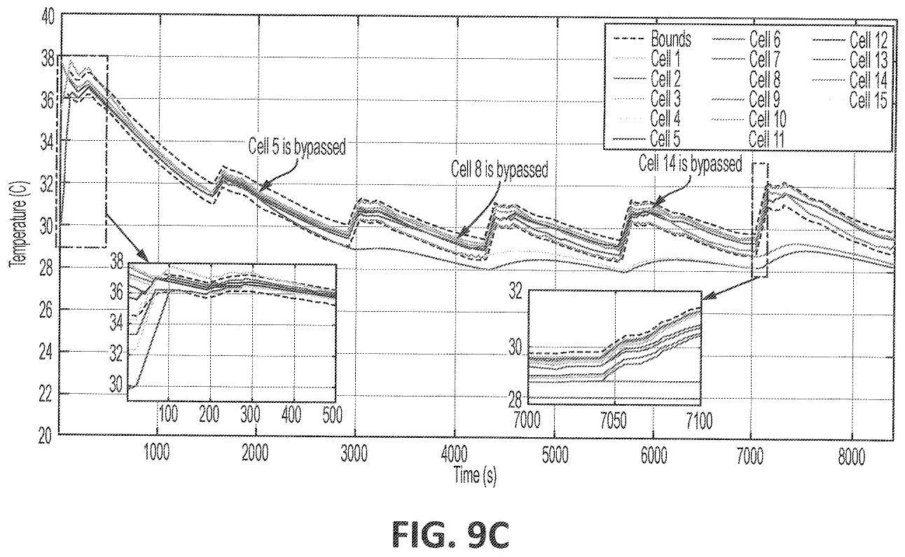

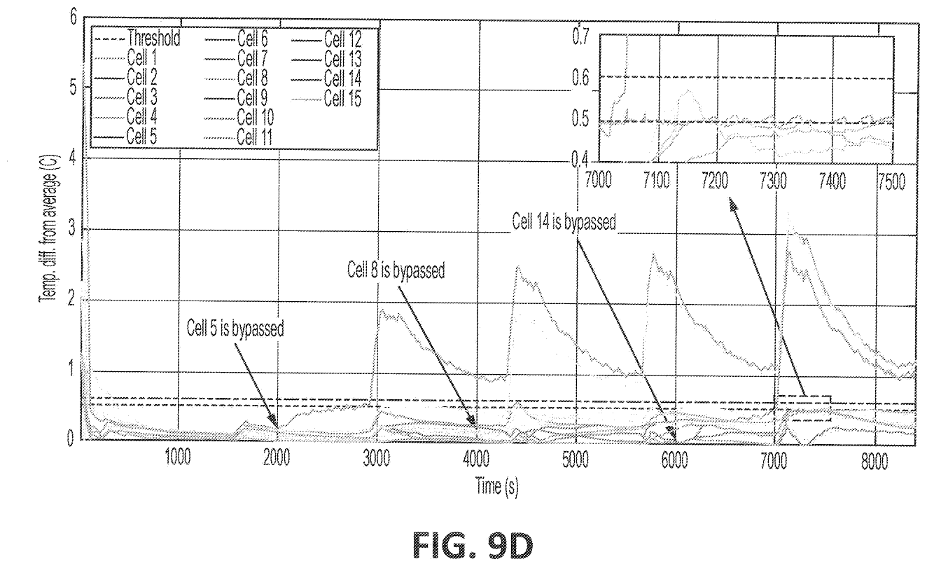

In FIGS. 9A-9D, show diagrams illustrating the SoC and temperature balancing performance using the proposed power management approach. The tolerated SoC and temperature deviation bounds, Δq and ΔT, are 1% and 0.5 K, respectively. According to FIG. 9A, the cells are different in their initial SoC. Among them, cell 2 had the lowest initial SoC of 86.48%, and cell 15 had the highest SoC of 92.61%. The difference was beyond the desired error bounds. However, the power management approach successfully drives the SoC of the cells to reach within the bounds after 200 seconds and continues to regulate the charging/discharging power of the cells to ensure SoC balance in the battery pack. Both cells 2 and 15 end up with the same SoC of 8.2% when the simulation is finished. It is noted that incorporating the slack variables demonstrates they can be used to guarantee the feasibility of the power optimization. The plot of FIG. 9B illustrates the deviation of the cells' SoC from the average. Some of the cells initially are beyond the tolerance bound of 1%—for example, cell 15 deviates from the average SoC by 3.5%. In this case, the optimization problem would have been infeasible, but this issue is avoided as the slack variable ξ^{(E)} permit slight violation of the SoC balancing constraints with negligible compromise to physical safety of the cells. Meanwhile, the penalization of ξ^{(E)} as in (21) in the cost function forces the cells to remain within the tolerated error bounds once after they enter the bounds, keeping the SoC and temperature balanced. The SoC of the bypassed cells remains unchanged after isolation as the cells are no longer used.

The plot in FIG. 9C shows the evolution of the cells' temperature. Similar to the SoC initialization, the initial temperatures of the cells stretch beyond the desired bounds where cells 1 and 2 have the highest and lowest temperature of 37.92° C. and 29.73° C., respectively. The power management approach effectively controls the cell temperatures to reach a balanced temperature after 500 seconds. Note that a cell's temperature is still affected by the temperature of its adjacent cells and the environment after it is bypassed. As shown in FIG. 9B, when the average temperature of the battery pack increases, the temperature of the bypassed cells also rises due to the conductive heat transfer among adjacent cells. Here, even though the cells' initial temperature difference exceeds the bound of 0.5 K, as shown in FIG. 9D, the optimization for temperature balancing maintains feasibility as a result of introducing the slack variable ξ^{(T)}.

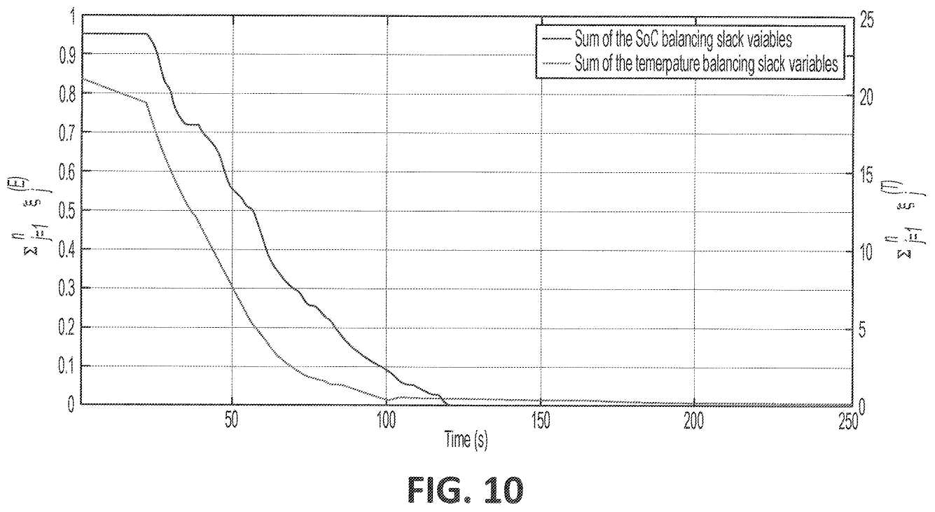

To further investigate the role of the slack variables in the formulated optimization problem, FIG. 10 depicts their evolution through time. When the cells' SoC or temperature lies outside the balancing constraints, the slack variables will take nonzero values to relax the balancing constraints gently, thus turning the nominally infeasible optimization problem into a feasible one. Penalizing the slack variables restricts over-relaxation of the constraints and tightens the bounds as the SoC and temperature get closer to or into the constraints. Zero slack variables suggest the SoC and temperature balancing constraints are satisfied. The penalization weights associated with the slack variables are subject to tuning so as to achieve the performance desired by a user. In general, heavier penalization will lead to less constraint relaxation and more time to achieve balancing.

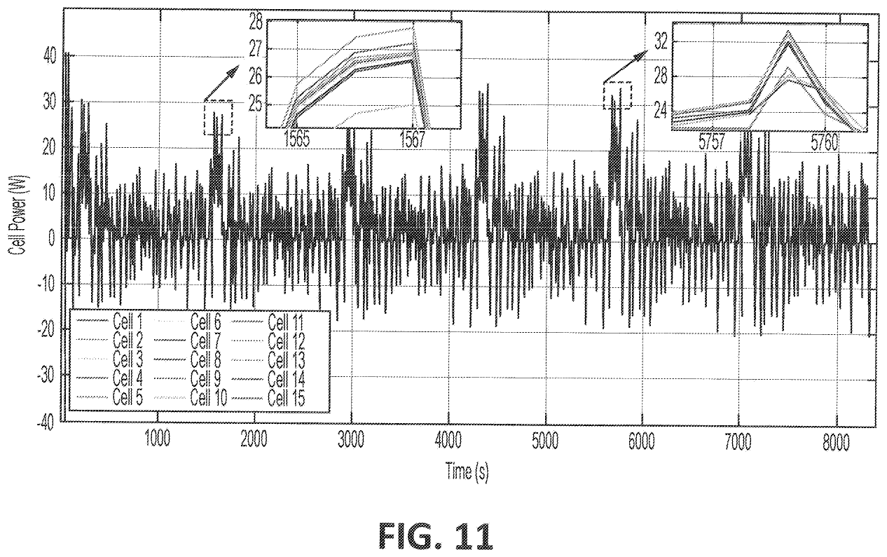

The output power profiles of the cells are shown in FIG. 11, which shows a diagram illustrating the power of the individual cells is regulated to vary from one to another. This is because the cells have different conditions in SoC, temperature and internal resistances and must collectively minimize the overall power losses while complying with safety and balancing constraints. The cells can also adjust their own output on the bypass of a faulty cell. The peak power of battery cells are around 28 W for 1; 560<t<1; 570 s before any cells are bypassed from the pack. However, when three cells are bypassed from the pack, the peak power of the remaining cells is increased to around 33 W for 5; 750<t<5; 760 s to compensate for the bypassed cells and to ensure a continuous power supply to the load.

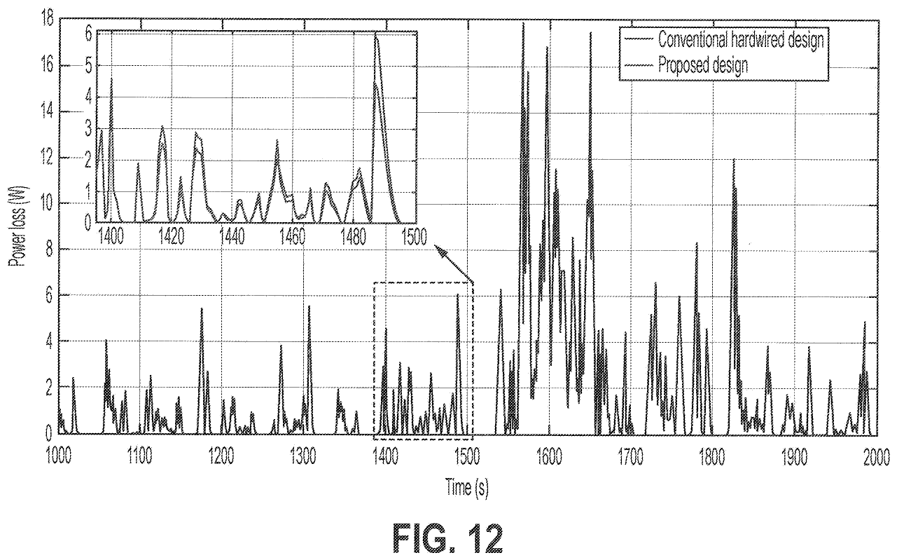

The total power losses on the internal resistances of the cells are shown in FIG. 12 to investigate how the proposed power management approach minimizes the power losses versus the conventional hardwired battery pack architectures. In FIG. 12 the focus was on the time window of 1; 000<t<2; 000 s for better visualization. Neglecting the mismatch in the internal resistances of the cells, the power dissipation of the conventional architectures is higher, consequently resulting in higher operating temperatures for the cells. On the other hand, the proposed power management approach optimally allocates the charging/discharging power among the cells to realize the minimum power loss.

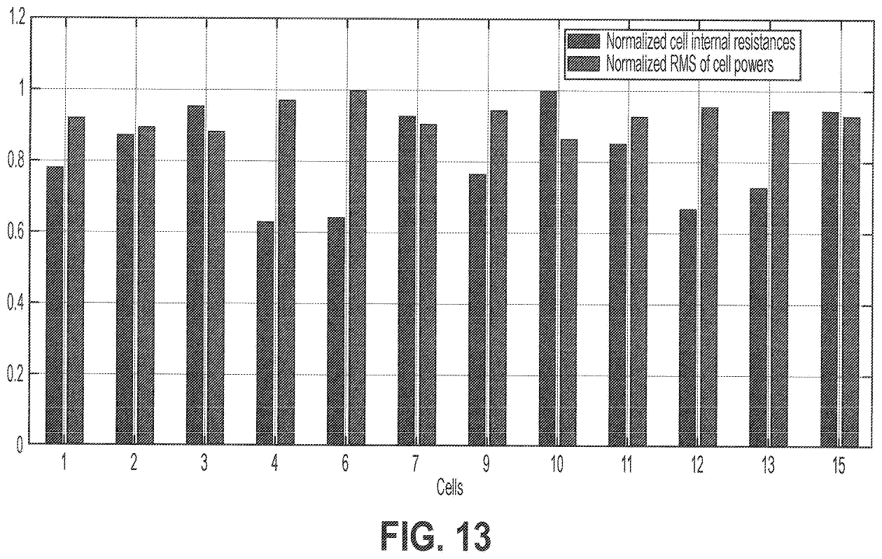

To further assess whether the proposed power management approach can distribute power among the cells relative to their state-of-health (SoH), which is important to reduce the cell aging and degradation. To this end, the root-meansquare (RMS) of the output power of the cells may be considered, and the internal resistance may be used as the SoH indicator-overall, the higher the internal resistance, the more degraded the cell is. FIG. 13 illustrates the normalized RMS of the output power of the battery cells in comparison to their internal resistance values. It can be observed in FIG. 13 that the cells with lower resistances are allocated more power load overall, see the groups of cells 1-4, cells 6-7, and cells 9-10. While the pattern is apparent, the power distribution also depends on each cell's SoC and temperature and thus shows certain perturbations. It can also be seen that the power management approach described above contributes to a balanced use of the battery cells in terms of SoH.

### EXPERIMENTAL RESULTS

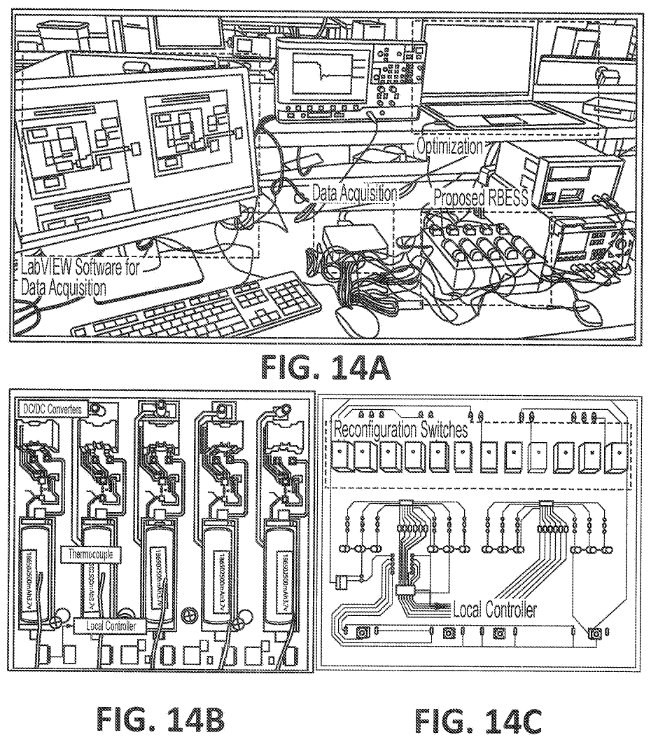

To evaluate the above-described RBESS concepts, a lab-scale prototype of the proposed RBESS was developed for experimental validation. FIG. 14A shows the experimental setup, and FIGS. 14B and 14C illustrate the circuit boards of the RBESS prototype based on the design in FIGS. 2 and 5. The RBESS is a pack of five cells integrated with five converters (FIG. 14B) and 12 power relays as reconfiguration switches (FIG. 14C). Table II below lays out the specifications of the key components of the prototype. Type K thermocouples are attached on the surface of each cell to measure their temperature. A National Instruments PCIe-6321 DAQ board with the Lab VIEW software was used to collect the cells' voltages, temperatures, and output power data. Using the CVX package, the optimal power management problem was solved (e.g., in MATLAB software) every minute (i.e., Δt=60 s). The optimal power values of cells were fed to local controllers using a DSP TMS320F28335. The local controllers, implemented by STM8S003F3P6 microcontrollers, generated 250 kHz PWM signals to DC/DC converters. The prototype was connected to a 20 resistance load with a total output discharge power of 50 W.

TABLE II
LIST OF KEY COMPONENTS

| Device | Model (Value) |
|---|---|
| MOSFET | CSD86356Q5D |
| Power relay | TE OJT-SS-105HM |
| Gate driver | TPS28225 |
| Inductor | SER2915H-333KL (33 μH) |
| Capacitor | (10 μF) |
| Local controller | STM8S003F3P6 |
| Main controller | TMS320f28335 |
| Battery cell | Samsung INR18650-25R |

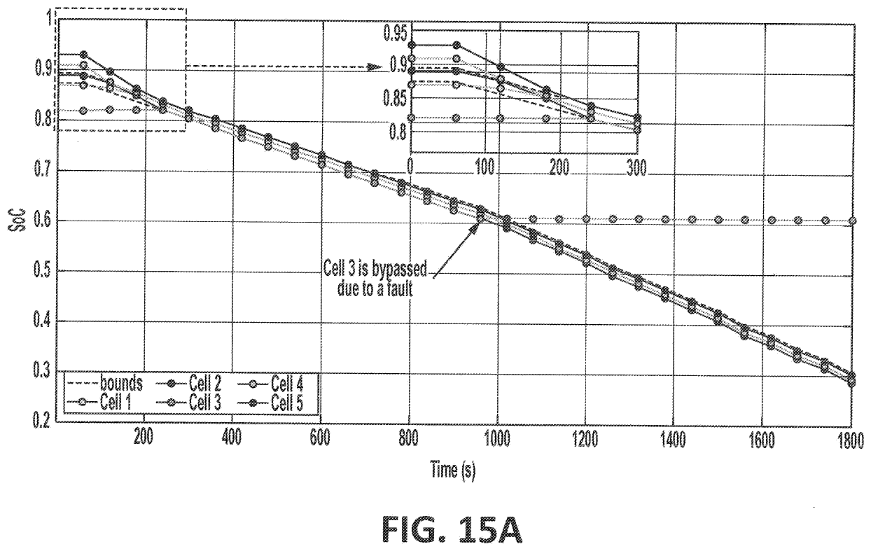

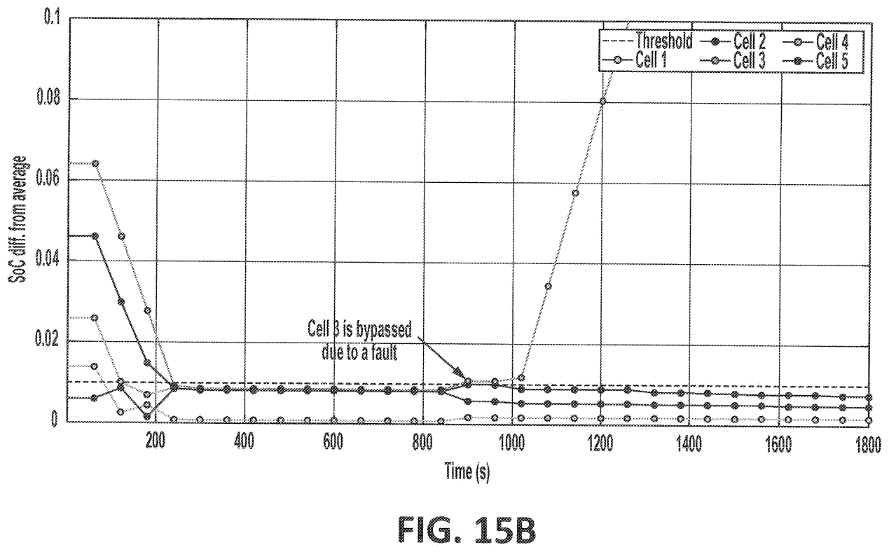

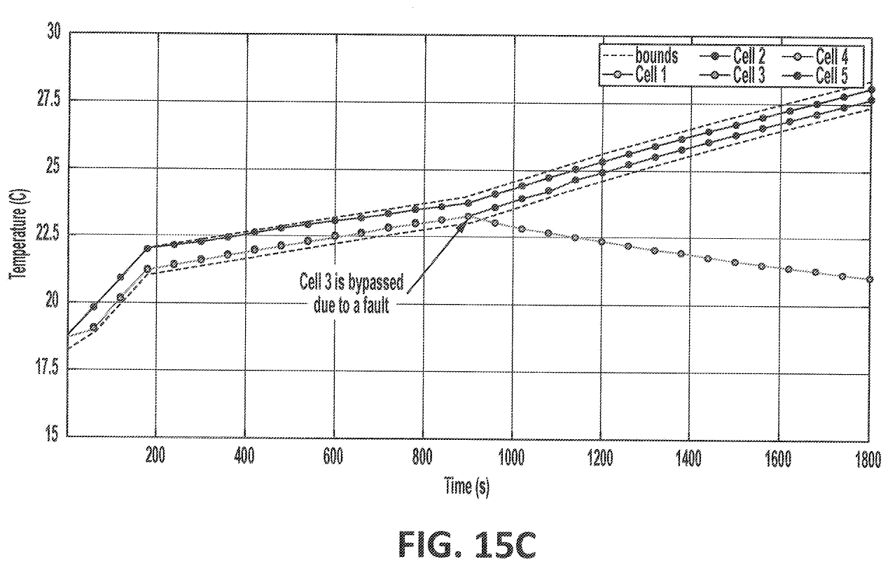

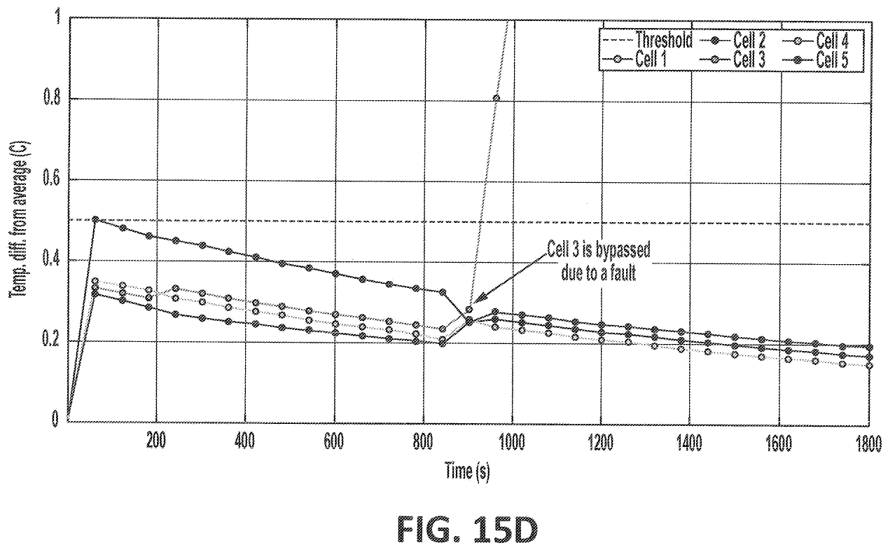

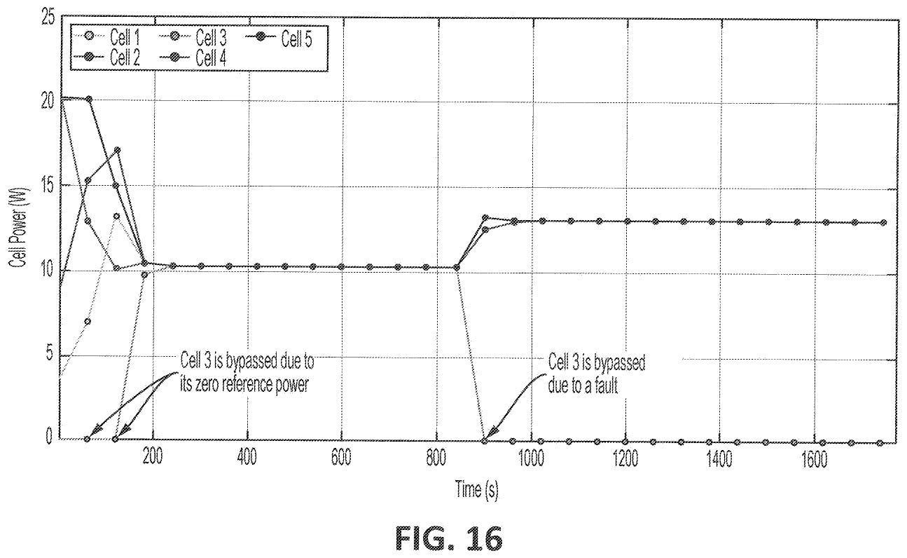

The cells, labeled from 1 to 5 in order, had an initial SoC of 87%, 89%, 82%, 91%, and 93%, respectively. The experiment lasted for 30 minutes with the sampling time of Δt=60 s. Each cell's output current was limited to 5 A. To investigate the effect of fault occurrence, a fault is assumed for cell 3 after 15 minutes of discharging in the experiment. The results obtained via the experimental setup described above are shown in FIGS. 15A-16.

FIG. 15A is a diagram that shows the SoC of the battery cells. The initial SoC values of the cells are not within the desired tolerance bound. However, the optimal power management approach successfully distributes the discharging power among the cells such that the cells reach the SoC balancing bounds after about four minutes. The corresponding output power profiles of the cells are shown in FIG. 16. It can be seen that cell 3, with the lowest initial SoC, is assigned zero power load (and thus bypassed by reconfiguration) in the first two minutes, while cell 5, with the highest SoC, delivers the maximum allowed power. Not only does the proper distribution of the output power leads to cell balancing, but the reconfiguration capability of the proposed design also helps cell balancing.

FIG. 15B also shows the SoC deviation of the cells from their average value. It is worthwhile to point out that, without the inclusion of the slack variables, the optimization would have been infeasible at the very initial moment when the SoC deviation goes beyond the SoC balancing constraint. FIG. 15C depicts the temperature of the cells. The initial temperature of all the cells is 20.7° C. Due to the uneven power distribution among the cells for SoC balancing, the cells will see their temperature rise and slightly drift away from each other. However, the deviation remains within the desired bound without violating the temperature balancing constraint. FIG. 15D also shows the temperature deviation of the cells from the average value. The difference increases from zero to the pre-specified bound of 0.5° C. in the beginning. But afterwards, it shows a declining trend and is well bounded.

When a fault occurs to cell 3 after 15 minutes of discharging, the cell is bypassed and isolated, as indicated in FIG. 16. Right after this happens, the other four cells that remain in service increase their discharging power accordingly, continuing to supply a total output power of 50 W as demanded. This highlights the benefit of the proposed RBESS in ensuring robust and consistent operation despite cell faults.

As shown above, the RBESS architecture and methodology described herein offer an important way to enhance the safe use of lithium-ion batteries (or other power storage devices). The modular RBESS design disclosed herein, which integrates reconfigurable power switches and DC/DC converters, harnesses the switching circuit reconfiguration to bypass any defective cells, and exploits the DC/DC converters to facilitate optimal power distribution at the cell level and ensure consistent power storage/supply at the system level. Based on the RBESS architecture disclosed herein, a power management approach to achieve power-loss-minimized operation of the RBESS along with SoC and temperature balancing among the cells may be achieved, as described above. Compared to existing methods, the approach disclosed herein allows wide-SoC-range operation of the cells by multi-segment SoC/OCV approximation and guarantees the feasibility of the optimization problem via mild relaxation. Extensive simulations were conducted and used to develop a labscale prototype of the RBESS design to perform validation experiments. The results substantiate the effectiveness of the proposed design and the power management approach disclosed herein. The benefits provided by the RBESS architecture disclosed herein can benefit and potentially drive the use of lithium-ion batteries for safety-critical applications or other use cases.

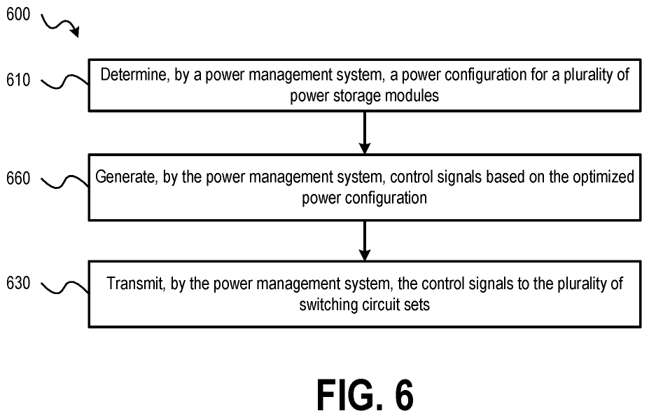

Referring to FIG. 6, a block diagram of a method for controlling an RBESS in accordance with aspects of the present disclosure is shown as a method 600. In an aspect, operations of the method 600 may be storage as instructions that, when executed by one or more processors, cause the one or more processors to perform operations in accordance with the method 600. In an aspect, the method 600 may be performed by a power management system, such as the power manager 116 or the power manager 500 of FIG. 5. Additionally, it is noted that the method 600 may be applied to RBESS in a variety of configurations, such as those described above with reference to FIGS. 2-5.

At step 610, the method 600 includes determining, by a power management system, a power configuration for a plurality of power storage modules. As explained above, the optimized power configuration seeks to balance a power load across active (e.g., non-bypassed) power storage modules (e.g., the modules associated with cells 201, 211, 221, 231 described with reference to FIG. 2, the RBESS modules 310, 320, 330, 340 of FIG. 3, the cells 410, 420, 430 of FIG. 4, etc.). As explained above, each power storage module includes a power storage device and a power converter.

At step 620, the method 600 includes generating, by the power management system, control signals based on the optimized power configuration. In an aspect, the control signals may be configured to open/close different switches of a plurality of switching circuit sets according the optimized power configuration. As explained above, the switching circuit sets may be positioned between adjacent power storage modules, as shown in FIGS. 2-5. The opening and closing of the different switches may be used to connect the adjacent modules in parallel or series or to bypass a module, as described above.

At step 630, the method 600 includes transmitting, by the power management system, the control signals to the plurality of switching circuit sets. As explained above, the power load determined by the power management system may be balanced across the active power storage modules based on the opening/closing of the switches of each switching circuit set. In determining the optimized power configuration the power management system may take into account a variety of factors, such as temperature information, SoC information, or other factors, as explained in the detailed examples above.

Using the concepts disclosed herein and described in more detail above with reference to FIGS. 1-5 and 7-16, the method 600 provides many advantages over existing BESS and RBESS designs. First, RBESS in accordance with the present disclosure enables cell balancing on an individual cell-by-cell basis and may take into account various real-time system conditions (e.g., SoC and temperature). In the disclosed RBESS, the SoC balancing issue may be alleviated because each battery cell is individually managed, and its charging/discharging power can be controlled via its corresponding power converter. In some situations, the charging/discharging power of all cells can be controlled so that the SoC levels of all battery cells are equalized. Furthermore, SoC balancing can be performed concurrently along with charging/discharging. In the discharging cycle, battery cells with higher SoC levels can be controlled to provide relatively more power to the load than the cells with lower SoC levels. Over time, this may equalize the SoC of all cells, allowing them to be operated at the same loads and drawing down the SoC of all cells evenly. On the other hand, battery cells with lower SoC levels can be controlled to receive relatively more power in the charging cycle. The proposed SBESS structure does not require any additional or external power electronic devices for charging/discharging and cell equalization, and can perform both functions simultaneously. It is noted that cell balancing using RBESS techniques in accordance with the present disclosure does not solely consider cell SOC levels. For example, load sharing or active energy allocation among the cells can be interpreted as the capability to actively control the cell temperatures. The generated heat can also be shared among the cells making sure that cell temperatures are equalized and do not exceed their maximum values, as described above. This capability helps contribute to the system's improved safety and reliability.

Another advantage provided by the RBESS techniques disclosed herein is improved fault tolerance and improved reliability. Operational safety and reliability are essential for the use of lithium-ion battery systems in high-stakes, safety-critical applications across the transportation, grid, aerospace and military sectors. This fact serves as a main motivation for the proposed RBESS, which, by design, offers the promise of being safer and more reliable due to its capability of reconfigurability, which makes the isolation of faulty components possible in the system. Power electronic converters also make the faults tolerable by providing output voltage regulation capability that enable power loss to be minimized when a cell is isolated (e.g., bypassed). It is also important to note that as each battery cell is connected to a power electronic converter, the failure in each one of them will result in the isolation of the cell from the array. In other words, possible failures in the power converters are tolerable as well. Another important characteristic of the proposed RBESS is its output voltage regulation capability in its discharging mode. When a fault occurs to a battery cell, the faulty battery cell will be bypassed and isolated from the array. If no measures are to be taken, the total output voltage of the array will be reduced, as is experienced in current BESS and RBESS designs. However, with the integration and control of power converters, the output voltage can be regulated to immediately recover from the effect due to the bypass of the faulty cell. This means that the RBESS can maintain its pre-specified reference output voltage.

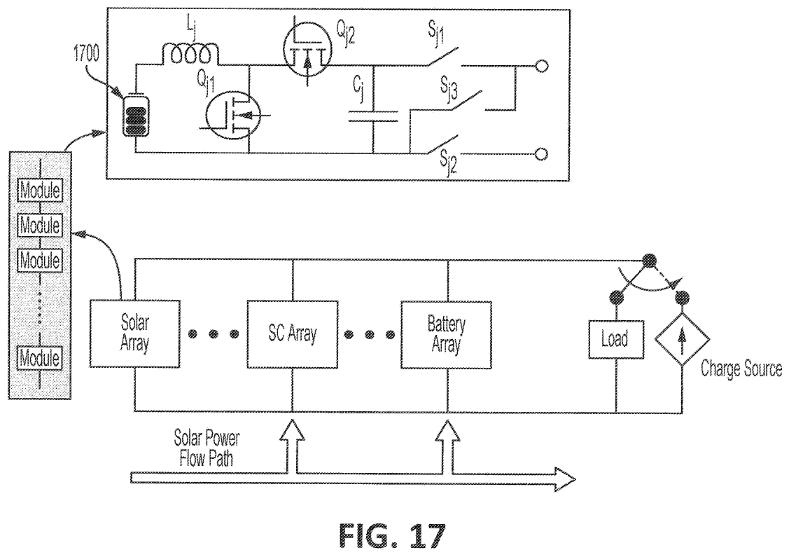

The RBESS techniques disclosed herein also enable hybrid realizations for energy storage systems by providing functions and advantages beyond the reach of conventional battery systems and designs. To illustrate, a conventional BESS is required to use battery cells of the same type and produced by the same manufacturer. The main reason for identical battery cells is to mitigate the degradation and aging mismatches among battery cells. However, the proposed RBESS design obviates such a need, to the benefit of some practical applications. For example and as explained above with reference to FIGS. 2-5, different types of battery cells can be utilized in a single RBESS, which improves the versatility of the proposed system. Hybrid supercapacitor (SC)/battery cell energy storage systems can also be realized using the proposed RBESS. Furthermore, since the power transfer is possible among the arrays, solar panels can be incorporated into the RBESS, and the generated solar energy can be used to supply the load and charge the battery cells. A diagram illustrating an example of a hybrid RBESS system is depicted in FIG. 17 and includes a solar panel 1700. As shown in FIG. 17, the solar array is able to charge the battery and supercapacitor arrays and supply the load when required. The hybridization flexibility of the RBESS presents unique features that can be a key enabling factor for realizing some new power storage and discharge applications.

Another advantage is that RBESS techniques according to the present disclosure do not need external charging and discharging interfaces. In the traditional BESS, a power electronic converter capable to handling the power rating of the whole battery pack is required to charge and discharge the battery pack. This solution is not suitable for large-scale energy storage systems, such as the exemplary energy storage system described with reference to FIG. 1C. However, in the proposed RBESS architecture, it is not required to employ a power electronic converter for charging and discharging because each module is managed individually by its corresponding power electronic converter. Therefore, the power rating of the converters is selected according to the power rating of each battery cell. In other words, it is more favorable to distribute the power among small-size high efficiency converters.

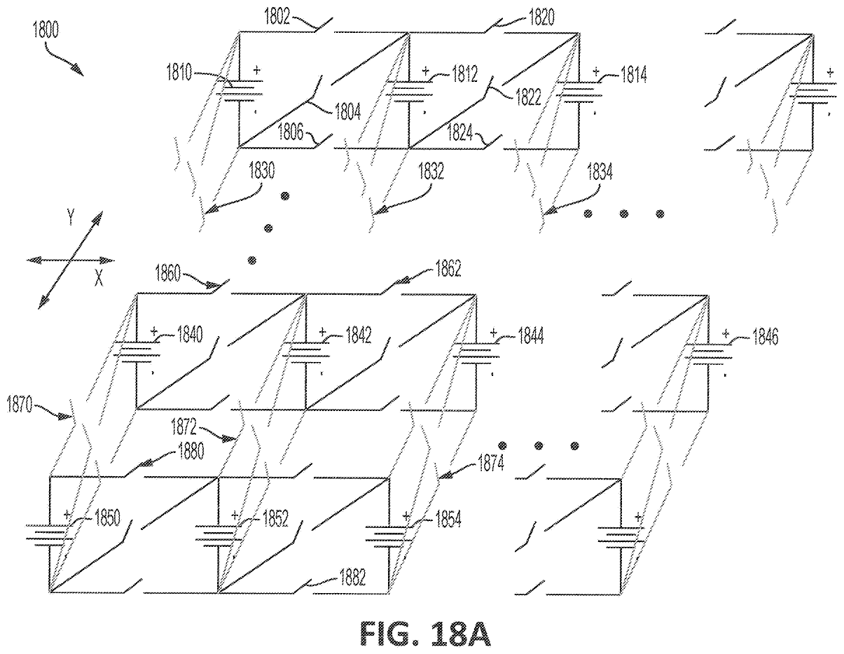

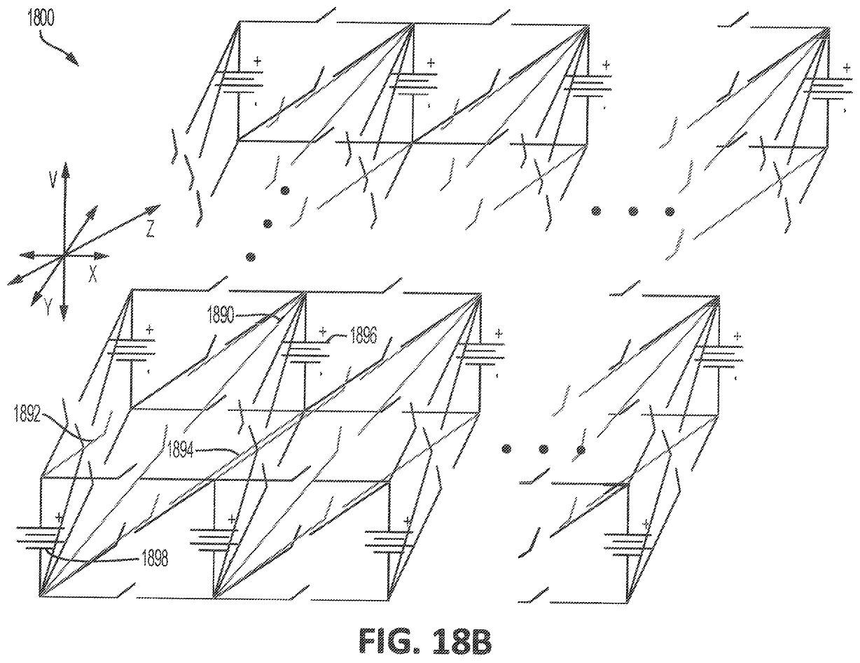

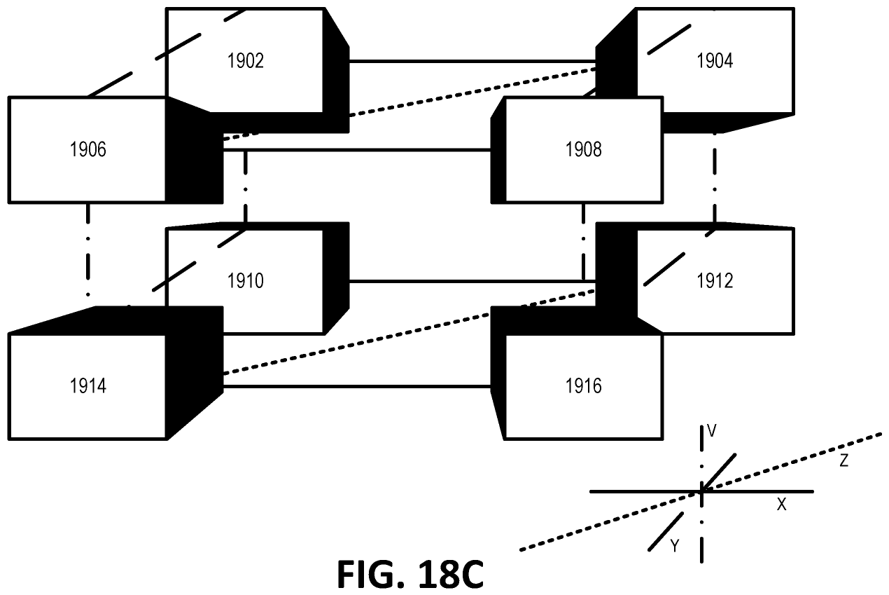

Referring to FIG. 18A, a block diagram illustrating an embodiment of a 3-dimensional RBESS in accordance with aspects of the present disclosure is shown as an RBESS 1800. It is noted that in FIG. 18A only certain components of the RBESS architecture are shown, but it should be readily understood that the RBESS 1800 includes power storage devices, power converters, and switching circuits in a manner similar to the RBESS architectures described above with reference to FIGS. 2-5 and 17.

As shown in FIG. 18A, the RBESS architecture 1800 includes power storage modules (e.g., cells and power converters) 1810, 1812, 1824, 1840, 1842, 1844, 1846, 1850 and additional unnumbered power structures. Additionally, the RBESS architecture 1800 includes switching circuits disposed between adjacent (e.g., in 2 dimensions X, Y) power storage modules. To illustrate, power structures 1810, 1812 have a switching circuit set disposed therebetween including switches 1802, 1804, 1806, and the power storage modules 1812, 1814 are shown having a switching circuit set disposed therebetween including switches 1820, 1822, 1824. Similarly, switching circuit set 1830 is disposed between power storage modules 1820 and 1840; switching circuit set 1832 is disposed between power storage modules 1812, 1842; switching circuit set 1834 is disposed between power storage modules 1814, 1844; switching circuit set 1860 is disposed between power storage modules 1840 and 1842; switching circuit set 1862 is disposed between power storage modules 1842, 1844; switching circuit set 1870 is disposed between power storage modules 1840, 1850; switching circuit 1872 is disposed between power storage modules 1842, 1852; switching circuit 1872 is disposed between power storage modules 1844, 1854; switching circuit 1880 is disposed between power storage modules 1850, 1852; and switching circuit 1882 is disposed between power storage modules 1852, 1854. It is noted that additional switching circuits/switching circuit sets are shown in FIG. 18A but not explicitly labeled or described for simplicity. It is noted that in FIG. 18A the power storage modules are adjacent in the X, Y directions, where the X and Y directions may be orthogonal (e.g., perpendicular).

Referring to FIG. 18B, another block diagram illustrating another embodiment of a 3-dimensional RBESS in accordance with the present disclosure is shown as an RBESS architecture 1800′. The RBESS architecture 1800′ may be similar to that illustrated in FIG. 18A except the RBESS architecture 1800′ includes switching circuit sets between diagonally adjacent (e.g., in the Z direction) power storage modules. For example, FIG. 18B shows power storage modules 1896, 1898 having a switching circuit set including switches 1890, 1892, 1894 disposed therebetween.

As can be appreciated from the exemplary RBESS architectures 1800, 1800′ shown in FIGS. 18A, 18B, the RBESS architectures of the present disclosure provide a mechanism for creating large power storage systems capable of establishing complex networks of active power circuitry, thereby facilitating robust power output capabilities through individual control of each individual cell using the concepts described herein. It is noted that while FIGS. 18A, 18B illustrate certain implementations having various switching circuit and power storage module arrangements, such details have been provided by way of illustration rather than by way of limitation and other arrangements of power storage modules and switching circuits may also be provided. Furthermore, it should be that the exemplary RBESS architectures shown in FIGS. 2-5, 17, and 18A-18B could be stacked in a layered arrangement with switching circuit sets provided between one or more of the power storage modules in each layer (e.g., along the V direction), thereby providing additional complex architectures in accordance with the present disclosure. An example of such an arrangement is shown in FIG. 18C, which shows a plurality of power storage modules 1902, 1904, 1906, 1908, 1910, 1914, 1916, each coupled to one or more adjacent power storage modules in an X, Y, Z, or V direction, where different directions are represented by different line styles according to the legend provided.

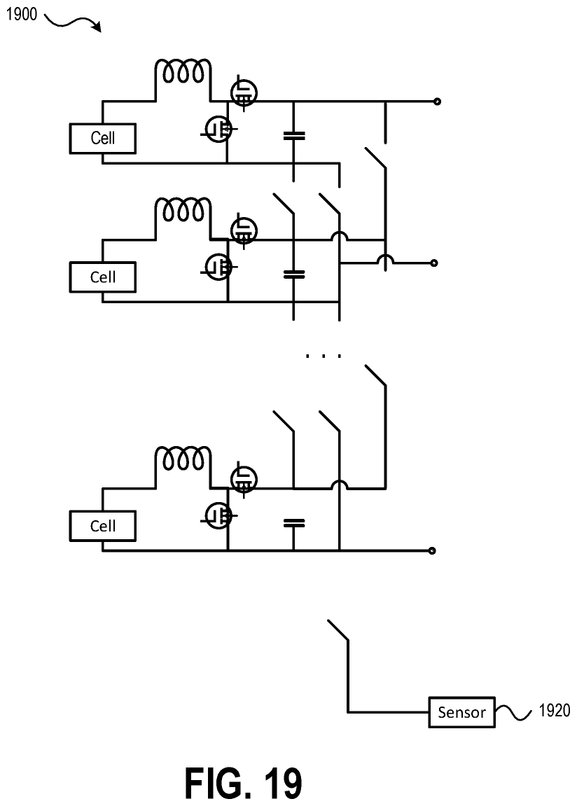

Referring to FIG. 19, a block diagram of an embodiment of a diagnostic circuit in accordance with aspects of the present disclosure is shown as a diagnostic circuit 1900. As shown in FIG. 19, the diagnostic circuit 1900 includes a plurality of power storage modules and switching circuit sets disposed between adjacent power storage modules. In an aspect, one or more sensors 1920 may be provided for performing diagnostics or other types of analysis with respect to the power storage modules or other aspects of an RBESS architecture in accordance with the present disclosure. Using the above-described switching techniques, the switching circuit sets may be controlled to couple one or more of the power storage modules to the sensor(s) 1920. Once coupled to the sensor(s) 1920, one or more diagnostic sensing operations may be performed. For example, the sensor(s) may be configured to detect faulty cells or measure other state-of-health information with respect to each of the power storage modules. By systematically coupling each power storage module to the sensor(s) 1920, diagnostic and state-of-health analysis may be performed for the entire RBESS architecture using a reduced number of sensors, thereby simplifying the design and reducing the manufacturing cost.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-6 include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A system comprising:
a plurality of power storage modules, wherein each power storage module of the plurality of power storage modules comprises a power storage device and a power converter;
a plurality of switching circuit sets, wherein each switching circuit set of the plurality of switching circuit sets positioned between adjacent power storage modules of the plurality of power storage modules; and
a power management system configured to:
determine a power configuration for the plurality of power storage modules, wherein the optimized power configuration balances a power load across active power storage modules of the plurality of power storage modules; and
transmit control signals to the plurality of switching circuit sets according to the power configuration, wherein the control signals are configured to open/close different switches of the plurality of switching circuit sets according to the optimized power configuration.

2. The system of claim 1, wherein the power storage devices of the power storage modules comprise heterogeneous power storage devices or homogeneous power storage devices.

3. The system of claim 1, wherein each power storage module comprises one or more sensors configured to:
monitor characteristics of the power storage device; and
provide sensor information associated with the characteristics of the power storage device, wherein the power management system is configured to determine the power configuration based at least in part on sensor information received from sensors of the plurality of power storage modules.

4. The system of claim 3, wherein the characteristics comprise a temperature, a state of charge of the power storage device, or both.

5. The system of claim 3, wherein the temperature corresponds to a temperature of the power storage device, a temperature of an ambient environment associated with the power storage device, or both.

6. The system of claim 1, wherein the power management system determines the power configuration for the plurality of power storage modules according to an optimization problem, and wherein the optimization problem is modified by the power management system to incorporate slack variables to guarantee feasibility of the optimization problem.

7. The system of claim 1, wherein the power configuration indicates at least one power storage module is to be bypassed, and wherein the control signals are configured to control switches of the plurality of switching circuit sets to bypass the at least one power storage module.

8. The system of claim 1, wherein the plurality of switching circuit sets comprise at least a first switching circuit set positioned between a first power storage module of the plurality of power storage modules and a second power storage module of the plurality of power storage modules, the first power storage module adjacent to the second power storage module with respect to a first direction.

9. The system of claim 8, wherein the plurality of switching circuit sets comprise at least a second switching circuit set positioned between the first power storage module and a third power storage module of the plurality of power storage modules, the first power storage module adjacent to the third power storage module with respect to a second direction.

10. The system of claim 9, wherein the first direction is orthogonal to the second direction.

11. The system of claim 9, wherein the plurality of switching circuit sets comprise at least a third switching circuit set positioned between the first power storage module and a fourth power storage module of the plurality of power storage modules, the first power storage module adjacent to the third power storage module with respect to a third direction.

12. A method comprising:
determining, by a power management system, a power configuration for a plurality of power storage modules, wherein the optimized power configuration balances a power load across active power storage modules of the plurality of power storage modules, and wherein each power storage module of the plurality of power storage modules comprises a power storage device and a power converter; and
generating, by the power management system, control signals based on the optimized power configuration, wherein the control signals are configured to open/close different switches of a plurality of switching circuit sets according the optimized power configuration, wherein a first switching circuit set of the plurality of switching circuit sets is positioned between a first power storage module of the plurality of power storage modules and a second power storage module of the plurality of power storage modules; and
transmitting, by the power management system, the control signals to the plurality of switching circuit sets, wherein the power load is balanced across the active power storage modules based on the opening/closing of the switches of each switching circuit set.

13. The method of claim 12, wherein the power storage devices of the power storage modules comprise heterogeneous power storage devices or homogeneous power storage devices.

14. The method of claim 12, further comprising:
receiving sensor information from sensors corresponding to the plurality of power storage modules, wherein sensor information received from a particular sensor of the sensors comprises temperature information associated with a temperature of a power storage device of the corresponding power storage module, a temperature of an ambident environment associated with the corresponding power storage module, a state of charge of the power storage device of the corresponding power storage module, or a combination thereof; and
determining the power configuration based at least in part on the sensor information received from the sensors.

15. The method of claim 12, wherein the power configuration for the plurality of power storage modules is determined according to an optimization problem, and wherein the optimization problem is configured with slack variables to guarantee feasibility of the optimization problem.

16. The method of claim 12, wherein the power configuration indicates at least one power storage module is to be bypassed, and wherein the control signals are configured to control switches of the plurality of switching circuit sets to bypass the at least one power storage module.

17. The method of claim 16, wherein the at least one power storage module is to be bypassed based on a state of charge condition of the power storage device of the at least one power storage module, wherein bypassing is determined when the state of charge condition indicates the power storage device is fully charged during a charging process or depleted of charge during discharging.

18. The method of claim 16, wherein the at least one power storage module is bypassed in response to detecting a fault.

19. The method of claim 12, wherein the opening/closing of the switches of each switching circuit set is configured to connect different power storage devices of the plurality of power storage modules in parallel or in series, or bypass one or more of the power storage devices.

20. The method of claim 12, wherein the active power storage modules correspond to power storage modules outputting power according to the power configuration based on the control signals, and wherein inactive power storage modules correspond to power storage modules that are bypassed and not outputting power according to the power configuration based on the control signals.

21. The method of claim 12, wherein the control signals are configured to control an amount of power drawn from or provided to each of the plurality power storage modules on an individual-per-power storage device basis.

22. The method of claim 12, wherein the control signals comprise a control signal for each switching circuit set of the plurality of switching circuit sets individually.

23. The method of claim 22, wherein each switching circuit set comprises three switches, and wherein the individual control signal for each switching circuit set is configured to control whether each of the three switches is in an open state or a closed state.

24. The method of claim 12, wherein the optimized power configuration is based on state of charge information, state of health information, temperature, or a combination thereof.
